(19) United States
(12) Patent Application Publication
(10) Pub. No.: US 2025/0383981 A1
(43) Pub. Date: Dec. 18, 2025

(54) APPARATUS CONFIGURED TO REGULATE THE INTAKE OF READ AND WRITE COMMANDS

(71) Applicant: MICRON TECHNOLOGY, INC., Boise, ID (US)

(72) Inventor: Nicola Del Gatto, Cassina de’ Pecchi (IT)

(73) Assignee: MICRON TECHNOLOGY, INC., Boise, ID (US)

(21) Appl. No.: 19/226,469

(22) Filed: Jun. 3, 2025

Related U.S. Application Data
(60) Provisional application No. 63/659,985, filed on Jun. 14, 2024.

(51) Int. Cl. G06F 12/02

(52) U.S. Cl. CPC G06F 12/0223; G06F 2212/25

(57) ABSTRACT

Managed memory controllers might include a plurality of host interface ports, a read buffer comprising read buffer entries, a write buffer comprising write buffer entries, and a central controller configured to cause the managed memory controller to regulate intake of read commands at an individual host interface port in response to a first number of read buffer entries plus write buffer entries that are allocated to any of the host interface ports, a second number of read buffer entries plus write buffer entries that are allocated to the individual host interface port, and a third number of read buffer entries that are allocated to the individual host interface port, and regulate intake of write commands at the individual host interface port in response to the first number, the second number, and a fourth number of write buffer entries that are allocated to the individual host interface port.

### RELATED APPLICATIONS

This application claims the benefit of U.S. Provisional Application No. 63/659,985, filed on Jun. 14, 2024, hereby incorporated herein in its entirety by reference.

### TECHNICAL FIELD

The present disclosure relates generally to integrated circuits, and, in particular, in one or more embodiments, to facilitating improved control of read and write commands running in a managed memory controller of an apparatus, e.g., a memory expansion module, including regulating the intake of read and write commands received by the managed memory controller, e.g., from an external host.

### BACKGROUND

Memory devices (also referred to as “memory media devices”) are widely used to store information in various electronic devices such as computers, servers, user devices, wireless communication devices, cameras, digital displays, and the like. Information is stored by programing memory cells within a memory device to various states. For example, binary memory cells might be programmed to one of two supported states, often corresponding to a logic 1 or a logic 0. In some examples, a single memory cell might support more than two possible states, any one of which might be stored by the memory cell. To access information stored by a memory device, a component might read, or sense, the state of one or more memory cells within the memory device. To store information, a component might write, or program, one or more memory cells within the memory device to corresponding states.

Various types of memory devices exist, including random access memory (RAM), read-only memory (ROM), dynamic RAM (DRAM), synchronous dynamic RAM (SDRAM), static RAM (SRAM), flash memory, and others. Memory devices might be volatile or non-volatile. Volatile memory cells (e.g., DRAM cells) might lose their programmed states over time unless they are periodically refreshed by an external power source. SRAM memory might maintain their programmed states for the duration of the system being powered on. Non-volatile memory cells (e.g., NAND memory cells) might maintain their programmed states for extended periods of time even in the absence of an external power source.

Memory devices might be coupled to a host (e.g., a host computing device) to store data, commands, and/or instructions for use by the host while the computer or other electronic system is operating. For example, data, commands, control signals and/or instructions can be transferred between the host and the memory devices during operation. A controller, which might be referred to as a “managed memory controller,” might be used to manage the transfer of data, commands, and/or instructions between the host and the memory devices.

The commands received by the managed memory controller from the host might include read commands and write commands. When the host sends a write command to the managed memory controller, the host system can still run independently while the memory devices store the associated data. However, when the host sends a read command to the managed memory controller, an application running on a processing device of the host might enter a paused state while waiting for data to be acquired from the memory devices in response to the sent read command.

The received commands, including the read and write commands, might impose a significant workload on the managed memory controller. This workload might result in a denial of service if the managed memory controller and/or the memory devices are unable to timely process the requests, at least in part due to limitations on their capabilities and a number of operations already queued up or being performed by the managed memory controller and/or the memory devices.

### BRIEF DESCRIPTION OF THE DRAWINGS

FIG. 1 illustrates an example of a memory device for use with various embodiments.

FIG. 2 is a functional block diagram of a managed memory controller of the related art.

FIG. 3 is a functional block diagram of an electronic system including a managed memory controller in accordance with an embodiment.

FIG. 4A is a block schematic of a read buffer in accordance with an embodiment.

FIG. 4B is a block schematic of a write buffer in accordance with an embodiment.

FIG. 5A is a block schematic of a read buffer in accordance with a further embodiment.

FIG. 5B is a block schematic of a write buffer in accordance with a further embodiment.

FIGS. 6A-6B are a flowchart of a method of operating a managed memory controller in accordance with an embodiment.

FIG. 7 is a flowchart of a method of operating a managed memory controller in accordance with a further embodiment.

FIG. 8 is a flowchart of a method of operating a managed memory controller in accordance with an embodiment.

FIG. 9 is a flowchart of a method of operating a managed memory controller in accordance with a further embodiment.

FIG. 10 is a flowchart of a method of operating a managed memory controller in accordance with a still further embodiment.

FIG. 11 is a flowchart of a method of operating a managed memory controller in accordance with one portion of the flowchart of FIG. 10.

FIG. 12 is a flowchart of a method of operating a managed memory controller in accordance with a different portion of the flowchart of FIG. 10.

### DETAILED DESCRIPTION

In the following detailed description, reference is made to the accompanying drawings that form a part hereof, and in which is shown, by way of illustration, specific embodiments. In the drawings, like reference numerals describe substantially similar components throughout the several views. Other embodiments might be utilized, and structural, logical, and electrical changes might be made without departing from the scope of the present disclosure. The following detailed description is, therefore, not to be taken in a limiting sense.

The term “conductive” as used herein, as well as its various related forms, e.g., conduct, conductively, conducting, conduction, conductivity, etc., refers to electrically conductive unless otherwise apparent from the context. Similarly, the term “connecting” as used herein, as well as its various related forms, e.g., connect, connected, connection, etc., refers to electrically connecting by an electrically conductive path unless otherwise apparent from the context.

As used herein, multiple acts being performed concurrently will mean that each of these acts is performed for a respective time period, and each of these respective time periods overlaps, in part or in whole, with each of the remaining respective time periods. In other words, portions of each of those acts are simultaneously performed for at least some period of time.

As used herein, multiple acts being performed sequentially will mean that each of these acts is initiated in sequence, one after another. For some embodiments, each act might be performed to completion before a next act is initiated. For other embodiments, one or more of the acts might be initiated prior to completion of one or more previously initiated acts.

It is recognized herein that even where values might be intended to be equal, variabilities and accuracies of industrial processing and operation might lead to differences from their intended values. These variabilities and accuracies will generally be dependent upon the technology utilized in fabrication and operation of the integrated circuit device. As such, if values are intended to be equal, those values are deemed to be equal regardless of their resulting values.

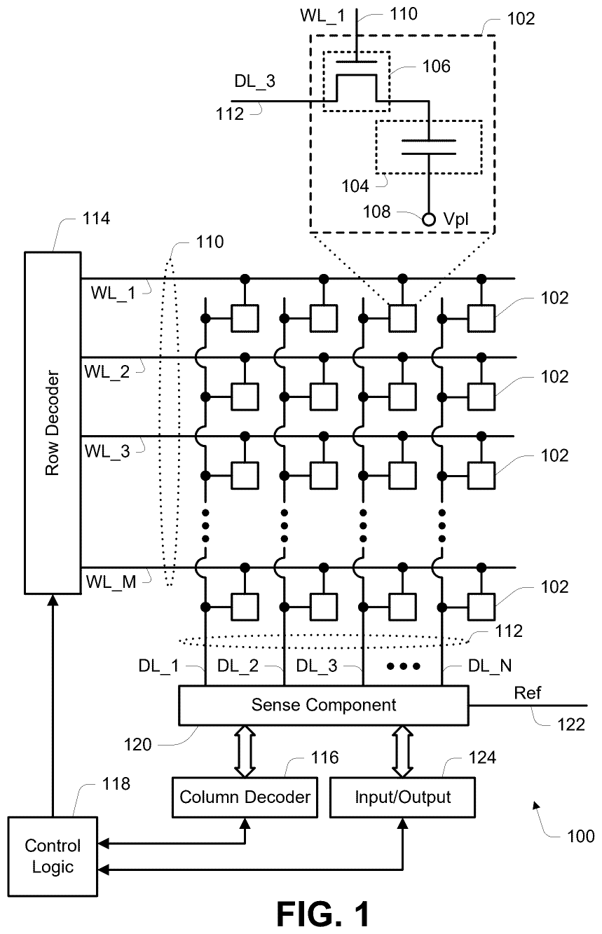

FIG. 1 illustrates an example of a memory device 100 for use with various embodiments. The memory device 100 might be referred to as a memory dice or memory chip. The memory device 100 might include one or more memory cells 102 that are programmable to store different logic states. Each memory cell 102 might be programmable to store two or more states. For example, the memory cell 102 might be configured to store one digit (e.g., bit) of information at a time (e.g., a logic 0 or a logic 1). In some cases, a single memory cell 102 (e.g., a multi-digit memory cell) might be configured to store more than one digit of information at a time (e.g., a two-digit memory cell might be configured to store a logic 00, logic 01, logic 10, or a logic 11).

In some cases, a memory cell 102 might store a charge representative of the programmable states in a capacitor (e.g., a capacitor 104). In DRAM architectures, the memory cell 102 might include a capacitor that includes a dielectric material to store a charge representative of the programmable state. In FeRAM architectures, the memory cell 102 might include a capacitor that includes a ferroelectric material to store a charge and/or a polarization representative of the programmable state. In some examples (not shown), a memory cell 102 might include or otherwise be associated with a configurable material, which might be referred to as a memory element or a memory storage element. A configurable material might have one or more variable and configurable characteristics or properties (e.g., material states) that are representative of (e.g., correspond to) different logic states. For example, a configurable material might take different forms, different atomic configurations, different degrees of crystallinity, different atomic distributions, or otherwise maintain different characteristics. In some examples, such characteristics might be associated with different electrical resistances, different threshold voltages, or other properties that are detectable or distinguishable during a read operation to identify a logic state stored by the configurable material. In other memory architectures, other storage devices and components might be used to support the techniques described herein. For example, in some other memory architectures, the memory cell 102 might store a charge representative of the programmable states in a transistor (e.g., in a floating gate of a transistor).

Operations such as reading and writing might be performed on memory cells 102 by activating or selecting access lines such as a word line 110 and/or a digit line 112. In some cases, digit lines 112 might also be referred to as bit lines. References to access lines, word lines and digit lines, or their analogues, are interchangeable without loss of understanding or operation. Activating or selecting a word line 110 or a digit line 112 might include applying a voltage level to the respective line.

The memory device 100 might include the access lines (e.g., the word lines 110 and the digit lines 112) arranged in a grid-like pattern. Memory cells 102 might be positioned at intersections of the word lines 110 and the digit lines 112. By biasing a word line 110 and a digit line 112 (e.g., applying a voltage level to the word line 110 or the digit line 112), a single memory cell 102 might be accessed at their intersection.

Accessing the memory cells 102 might be controlled through a row decoder 114 and a column decoder 116. For example, a row decoder 114 might receive a row address from the control logic 118 (e.g., a local controller) and activate a word line 110 based on the received row address. A column decoder 116 might receive a column address from the control logic 118 and might activate a digit line 112 based on the received column address. For example, the memory device 100 might include multiple word lines 110, labeled WL_1 through WL_M, and multiple digit lines 112, labeled DL_1 through DL_N, where M and N depend on the size of the memory array. Thus, by activating a word line 110 and a digit line 112, e.g., WL_1 and DL_3, the memory cell 102 at their intersection might be accessed. The intersection of a word line 110 and a digit line 112, in either a two-dimensional or three-dimensional configuration, might be referred to as an address of a memory cell 102.

The memory cell 102 might include a logic storage component, such as capacitor 104 or other storage element (e.g., a configurable material memory element), and in some examples might also include a switching component 106. The capacitor 104 might be an example of a dielectric capacitor or a ferroelectric capacitor. A first node (e.g., first electrode) of the capacitor 104 might be coupled with the switching component 106 and a second node (e.g., second electrode) of the capacitor 104 might be coupled with a voltage source 108. In some cases, the voltage source 108 might be the cell plate reference voltage, such as Vpl, or might be ground, such as Vss. In some cases, the voltage source 108 might be an example of a plate line coupled with a plate line driver. The switching component 106 might be an example of a transistor or any other type of switch device that selectively establishes or de-establishes electronic communication between two components, e.g., selectively connects or isolates the two components.

In the illustrated example, referring to a capacitive memory architecture, selecting or deselecting the memory cell 102 might be accomplished by activating or deactivating the switching component 106. The capacitor 104 might be in electronic communication with the digit line 112 using the switching component 106. For example, the capacitor 104 might be isolated from the digit line 112 when the switching component 106 is deactivated, and the capacitor 104 might be connected to the digit line 112 when the switching component 106 is activated. In some cases, the switching component 106 is a transistor and its operation might be controlled by applying a voltage level to the transistor control gate, where the voltage differential between the transistor control gate and transistor source might be greater or less than a threshold voltage of the transistor. In some cases, the switching component 106 might be a p-type field-effect transistor (pFET) or an n-type field-effect transistor (nFET). The word line 110 might be connected to the control gate of the switching component 106 and might activate/deactivate the switching component 106 based on a voltage level being applied to the word line 110.

A word line 110 might be a conductive line in electronic communication with a memory cell 102 that is used to perform access operations on the memory cell 102. In some architectures, the word line 110 might be connected to a control gate of a switching component 106 of a memory cell 102 and might be configured to control the switching component 106 of the memory cell. In some architectures, the word line 110 might be connected to a node of the capacitor of the memory cell 102 and the memory cell 102 might not include a switching component.

A digit line 112 might be a conductive line that connects the memory cell 102 with a sense component 120. In some architectures, the memory cell 102 might be selectively connected to the digit line 112 during portions of an access operation. For example, the word line 110 and the switching component 106 of the memory cell 102 might be configured to connect and/or isolate the capacitor 104 of the memory cell 102 and the digit line 112. In some architectures, the memory cell 102 might be connected to the digit line 112.

The sense component 120 might be configured to detect a state (e.g., a charge) stored on the capacitor 104 of the memory cell 102 and determine a logic state of the memory cell 102 based on the stored state. The charge stored by a memory cell 102 might be extremely small, in some cases. As such, the sense component 120 might include one or more sense amplifiers to amplify the signal output by the memory cell 102. The sense amplifiers might detect small changes in the charge of a digit line 112 during a read operation and might produce signals corresponding to a logic state 0 or a logic state 1 based on the detected charge. During a read operation, the capacitor 104 of memory cell 102 might output a signal (e.g., discharge a stored charge) to its corresponding digit line 112. The signal might cause a voltage level of the digit line 112 to change. The sense component 120 might be configured to compare the signal received from the memory cell 102 across the digit line 112 to a reference signal 122 (e.g., reference voltage). The sense component 120 might determine the stored state of the memory cell 102 based on the comparison. For example, in binary signaling, if a digit line 112 has a higher voltage level than the reference signal 122, the sense component 120 might determine that the stored state of memory cell 102 is a first logic level (e.g., a logic 1) and, if the digit line 112 has a lower voltage level than the reference signal 122, the sense component 120 might determine that the stored state of the memory cell 102 is a second logic level (e.g., a logic 0). The sense component 120 might include various transistors or amplifiers to detect and amplify a difference in the signals. The detected logic state of the memory cell 102 might be provided as an output of the sense component 120 (e.g., to an input/output 124), and might indicate the detected logic state to an external device (e.g., directly or using the control logic 118).

The control logic 118 might control the operation of memory cells 102 through the various components (e.g., row decoder 114, column decoder 116, and sense component 120). The control logic 118 might be configured to receive commands and/or data from an external memory controller (not depicted in FIG. 1), translate the commands and/or data into information that can be used by the memory device 100, perform one or more operations on the memory device 100, and communicate data from the memory device 100 to the external device in response to performing the one or more operations. The control logic 118 might generate row and column address signals to activate the target word line 110 and the target digit line 112. The control logic 118 might also generate and control various voltage levels or currents used during the operation of the memory device 100. In general, the amplitude, shape, or duration of an applied voltage level or current discussed herein might be adjusted or varied and might be different for the various operations discussed in operating the memory device 100.

In some cases, the control logic 118 might be configured to perform a write operation (e.g., a programming operation) on one or more memory cells 102 of the memory device 100. During a write operation, a memory cell 102 of the memory device 100 might be programmed to store a desired logic state. In some cases, a plurality of memory cells 102 might be programmed during a single write operation. The control logic 118 might identify a target memory cell 102 on which to perform the write operation. The control logic 118 might identify a target word line 110 and a target digit line 112 in electronic communication with the target memory cell 102 (e.g., the address of the target memory cell 102). The control logic 118 might activate the target word line 110 and the target digit line 112 (e.g., applying a voltage level to the word line 110 or digit line 112), to access the target memory cell 102. The control logic 118 might apply a specific signal (e.g., voltage level) to the digit line 112 during the write operation to store a specific state (e.g., charge) in the capacitor 104 of the memory cell 102, and the specific state (e.g., charge) might be indicative of a desired logic state.

In some cases, the control logic 118 might be configured to perform a read operation (e.g., a sense operation) on one or more memory cells 102 of the memory device 100. During a read operation, the logic state stored in a memory cell 102 of the memory device 100 might be determined. In some cases, a plurality of memory cells 102 might be sensed during a single read operation. The control logic 118 might identify a target memory cell 102 on which to perform the read operation. The control logic 118 might identify a target word line 110 and a target digit line 112 in electronic communication with the target memory cell 102 (e.g., the address of the target memory cell 102). The control logic 118 might activate the target word line 110 and the target digit line 112 (e.g., applying a voltage level to the word line 110 or digit line 112), to access the target memory cell 102. The target memory cell 102 might transfer a signal to the sense component 120 in response to biasing the access lines. The sense component 120 might amplify the signal. The control logic 118 might fire the sense component 120 (e.g., latch the sense component) and thereby compare the signal received from the memory cell 102 to the reference signal 122. Based on that comparison, the sense component 120 might determine a logic state that is stored on the memory cell 102. The control logic 118 might communicate the logic state stored on the memory cell 102 to an external memory controller (or other external device) as part of the read operation.

In some memory architectures, accessing the memory cell 102 might degrade or destroy the logic state stored in a memory cell 102. For example, a read operation performed in DRAM architectures might partially or completely discharge the capacitor of the target memory cell. The control logic 118 might perform a re-write operation or a refresh operation to return the memory cell to its original logic state. The control logic 118 might re-write the logic state to the target memory cell after a read operation. In some cases, the re-write operation might be considered part of the read operation. Additionally, activating a single access line, such as a word line 110, might disturb the state stored in some memory cells in electronic communication with that access line. Thus, a re-write operation or refresh operation might be performed on one or more memory cells that might not have been accessed.

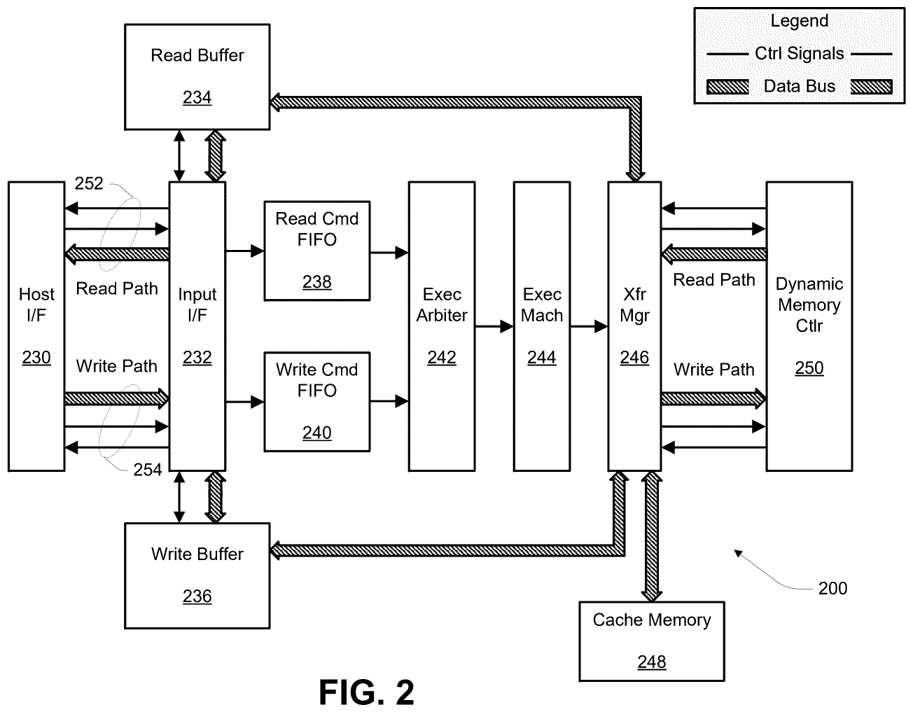

FIG. 2 is a functional block diagram of a managed memory controller 200 of the related art. The managed memory controller 200 might be configured to communicate with a host computing device (not depicted in FIG. 2) and one or more memory devices, such as the memory devices 100.

The managed memory controller 200 might be configured for controlling a maximum total number of read and write commands to be maintained by the managed memory controller 200. As depicted in FIG. 2, the managed memory controller 200 might include a host interface 230, an input interface 232, a read buffer 234, a write buffer 236, a read command FIFO 238, a write command FIFO 240, an execution arbiter 242, an execution machine 244, a transfer manager 246, a cache memory 248, and a dynamic memory controller 250.

The host interface 230 might be configured to communicate with a host (not depicted in FIG. 2) and the input interface 232 through input/output (I/O) paths such as control signal lines and data bus lines. A read path 252 might refer to control signal lines and data bus lines associated with a read request received by the managed memory controller 200 from a host. For example, control signals and read commands might be received by the managed memory controller 200 from a host across control signal lines, status information might be provided to the host from the managed memory controller 200 across control signal lines, and data read from an associated memory might be provided to the host from the managed memory controller 200 across data bus lines. For some embodiments, one or more control signal lines of the read path 252 might be the same communication signal lines as one or more of the data bus lines of the read path 252, e.g., a control signal line and a data bus line might be a same electrical path. A write path 254 might refer to control signal lines and data bus lines associated with a write request received by the managed memory controller 200 from a host. For example, control signals and write commands might be received by the managed memory controller 200 from a host across control signal lines, status information might be provided to the host from the managed memory controller 200 across control signal lines, and data to be written to an associated memory might be provided to the managed memory controller 200 from the host across data bus lines. For some embodiments, one or more control signal lines of the write path 254 might be the same communication signal lines as one or more of the data bus lines of the write path 254, e.g., a control signal line and a data bus line might be a same electrical path. In addition, one or more control signal lines of the read path 252 might be the same communication signal lines as one or more of the control signal lines of the write path 254, and one or more data bus lines of the read path 252 might be the same communication signal lines as one or more of the data bus lines of the write path 254.

Commands and other control signals, and/or data, might be communicated between the host and the input interface 232 through the host interface 230. The communications over the I/O paths to the host might be according to a protocol such as, for example, Peripheral Component Interconnect Express (PCIe). The plurality of I/O paths might be configured as a single port. The host interface 230 might handle the protocol such as the Compute Express Link™ (CXL) protocol to communicate with the host such that the managed memory controller 200 might be regarded as a “CXL Controller.”

The communications over the I/O paths to the host might include commands and/or control signals such as back pressure commands and/or control signals indicating to the host that no new read and/or write commands should be transmitted to the managed memory controller 200. These commands and/or control signals might reduce or completely stop data traffic such as read and/or write commands from being transmitted from the host to the managed memory controller 200 and thus to the memory devices as well. The host interface 230 might include interface management circuitry including data link and transaction control which might provide higher layer protocol support for communications with the host through the host interface 230.

The input interface 232 might communicate commands, control signals and/or data to the host through the host interface 230. The input interface 232 might handle input indication protocol and manage back pressure to the host. The input interface 232 might also be in communication with the read buffer 234, the write buffer 236, the read command FIFO 238, and the write command FIFO 240. The input interface 232 might communicate control signals and data with each of the read buffer 234 and write buffer 236 via corresponding control signal lines and data bus lines. The input interface 232 might communicate read commands to the read command FIFO 238 and might communicate write commands to the write command FIFO 240.

The read buffer 234 might store data received from the cache memory 248 and/or memory devices through the transfer manager 246 as a result of the execution of a read command by the managed memory controller 200. The read buffer 234 might also serve incoming read commands. The read buffer 234 might include a number (e.g., 64 or a multiple of 64) of entries, each of which might correspond to a read command.

A determination might be made regarding whether or not the read buffer 234 is fully allocated, that is, whether or not the capacity of the read buffer 234 for serving read commands has been completely reserved (e.g., all entries of the read buffer 234 are allocated). The number of entries allocated in the read buffer 234 for serving corresponding read commands might also be determined and added to a number of entries allocated in the write buffer 236 for serving write commands to determine a total sum of the allocated entries in the read buffer 234 and the write buffer 236.

The number of allocated entries might be used for comparison to a defined threshold to determine whether a new incoming read command can be requested or accepted by the managed memory controller 200. Alternatively, the number of entries can be used to determine whether a flow of new incoming read commands to the managed memory controller 200 is to be paused via asserted back pressure for read commands. The specific value of the defined threshold might be configurable and might be determined at least based on the amount of read and write traffic to the memory devices and/or the size of the cache memory 248.

The write buffer 236 might communicate data to the cache memory 248 and/or memory devices through the transfer manager 246 such that the data (e.g., data received from the host) might be written to the cache memory 248 and/or memory devices as a result of the execution of a write command by the managed memory controller 200. The write buffer 236 might also serve incoming write commands. The write buffer 236 might include a number (e.g., 64 or a multiple of 64, same as the read buffer 234) of entries, each of which might correspond to a write command.

A determination might be made regarding whether or not the write buffer 236 is fully allocated, that is, whether or not the capacity of the write buffer 236 for serving write commands has been completely reserved (e.g., all entries of the write buffer 236 are allocated). The number of entries allocated in the write buffer 236 for serving corresponding write commands might also be determined and added to the number of entries allocated in the read buffer 234 for serving corresponding read commands to determine a total sum of the used entries in the read buffer 234 and the write buffer 236. The number of entries might be used for comparison to the defined threshold to determine whether a new incoming write command can be requested or accepted by the managed memory controller 200. Alternatively, the number entries can be used to determine whether an input of a new incoming write command to the managed memory controller 200 is to be paused via asserted back pressure for write commands.

The read command FIFO 238 might be in communication with the input interface 232 and the execution arbiter 242. The read command FIFO 238 might store read commands received from the input interface 232. The stored read commands might be enqueued and then dequeued on a first-in, first-out basis. The read command FIFO 238 might, for example, include 64 entries (although this might be configured to be a different number of entries such as a multiple of 64), each entry forming or corresponding to a read command being handled by the managed memory controller 200. The read command FIFO 238 might have a same number of entries for storing read commands as a number of entries of the read buffer 234 for storing data associated with the stored read commands.

The write command FIFO 240 might be in communication with the input interface 232 and the execution arbiter 242. The write command FIFO 240 might store write commands received from the input interface 232. The stored write commands might be enqueued and then dequeued on a first-in, first-out basis. The write command FIFO 240 might, for example, include 64 entries (although this might be configured to be a different number of entries such as a multiple of 64), each entry forming or corresponding to a write command being handled by the managed memory controller 200. The write command FIFO 240 might have a same number of entries for storing write commands as a number of entries of the write buffer 236 for storing data associated with the stored write commands.

The execution arbiter 242 might select an enqueued command to be dequeued and executed from the read command FIFO 238 on a first-in, first-out basis or from the write command FIFO 240 on a first-in, first-out basis. The processing performed by the execution arbiter 242 might further give priority to dequeuing read commands.

The execution machine 244 might be in communication with the execution arbiter 242 and the transfer manager 246. The execution machine 244 might define a set of state machines configured to execute a command. This command might be the command selected by and received from the execution arbiter 242. Data and/or control signals might be output by the execution machine 244 as a result of the execution of the command to the transfer manager 246.

The transfer manager 246 might be in communication with the read buffer 234, the write buffer 236, and the cache memory 248. The transfer manager 246 might also be in communication with the memory devices through the dynamic memory controller 250. The transfer manager 246 might handle data moving between the read and write buffers 234 and 236, the cache memory 248 and the memory devices.

For example, when the managed memory controller 200 receives a read command from the host and that read command is dequeued from the read command FIFO 238 upon selection by the execution arbiter 242 and executed by the execution machine 244, the data requested might be transferred by the transfer manager 246 to the read buffer 234 from the cache memory 248 if available in that local cache memory 248. Alternatively, it might be transferred from external memory devices if the data requested is not available in that local cache memory 248.

As another example, when the managed memory controller 200 receives a write command from the host and that write command is dequeued from the write command FIFO 240 upon selection by the execution arbiter 242 and executed by the execution machine 244, the data to be written might be transferred by the transfer manager 246 from the write buffer 236 to the cache memory 248 and/or to external memory devices through the dynamic memory controller 250. In more detail, if a cache write policy is “Write Back,” data might always be moved from the write buffer 236 to the cache memory 248, and only during a cache line eviction process might data stored inside the cache memory 248 be moved to the memory devices. If the cache write policy is “Write Through,” the data might be moved from the write buffer 236 to the cache memory 248 and concurrently to external memory devices.

The dynamic memory controller 250 of the managed memory controller 200 might be configured to communicate with one or more types of memory devices (e.g., DRAM devices) through a plurality of channels, including control signal lines and data bus lines, which can be used to read/write data to/from the memory devices, to transmit commands to the memory devices, to receive status and statistics from the memory devices, etc., including command and data.

The maximum number of read and write commands maintained by the managed memory controller 200 and serviced by the read and write buffers 234 and 236 might be controlled by asserting back pressure on the host to pause the flow of new incoming read and/or write commands even if there is space available inside of the read and write buffers 234 and 236. Back pressure to pause the flow of new incoming read commands might further be asserted in response to the read buffer 234 being fully allocated, and back pressure to pause the flow of new incoming write commands might further be asserted in response to the write buffer 236 being fully allocated.

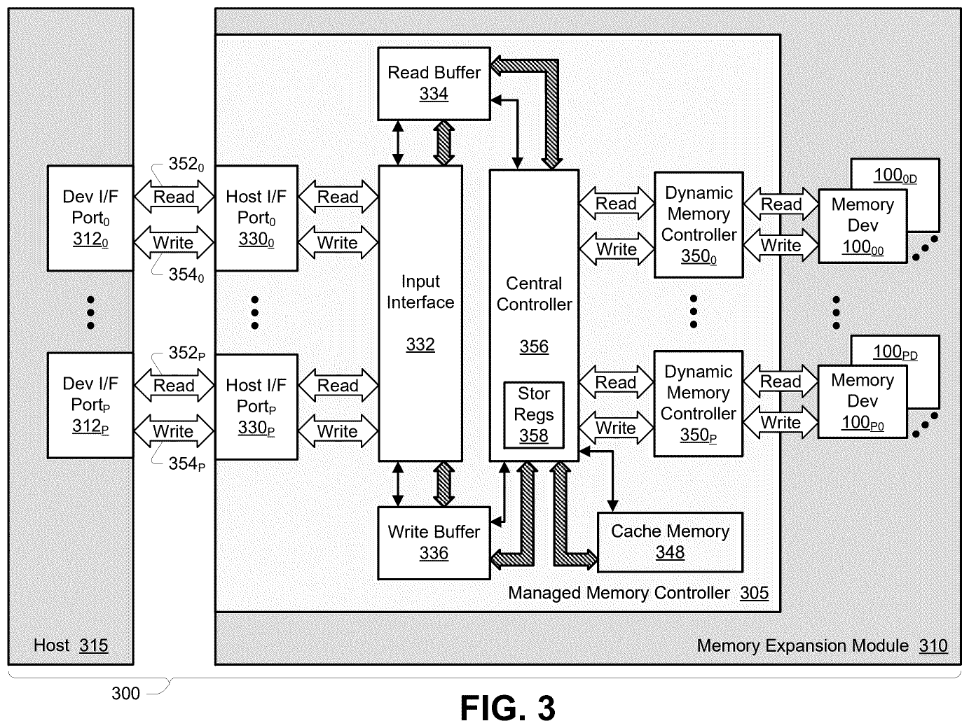

FIG. 3 is a functional block diagram of an electronic system having a first apparatus (e.g., a memory expansion module 310) including a second apparatus (e.g., a managed memory controller 305) and one or more third apparatus (e.g., memory devices 100) in communication with a fourth apparatus (e.g., a host computing device or host 315) in accordance with an embodiment.

The managed memory controller 305 might be configured for regulating a flow of read and write commands to be received by the managed memory controller 305. As depicted in FIG. 3, the managed memory controller 305 might include a plurality of host interface (I/F) ports 330, e.g., host interface ports 330₀-330_{P}. The value of P might be an integer value greater than or equal to one. The value of P+1 might further be some power of two, e.g., 2, 4, 8, 16, etc.

The host 315 might include a plurality of device interface ports 312, e.g., device interface ports 312₀-312_{P}. Each host interface port 330 of the managed memory controller 305 might be configured for communication with a corresponding device interface port 312 of the host 315. For example, the host interface port 330₀ of the managed memory controller 305 might be in communication with the device interface port 312₀ of the host 315 across an associated read path 352₀ and an associated write path 354₀, the host interface port 330₁ of the managed memory controller 305 might be in communication with the device interface port 312₁ of the host 315 across an associated read path 352₁ and an associated write path 354₁, the host interface port 330₂ of the managed memory controller 305 might be in communication with the device interface port 312₂ of the host 315 across an associated read path 352₂ and an associated write path 354₂, and so on. Although host interface ports 330₁ and 330₂ are not explicitly depicted in FIG. 3, it is apparent from the figure that the host interface ports 330 of the managed memory controller 305 might be numbered consecutively from host interface port 330₀ to host interface port 330_{P}. Similarly, although device interface ports 312₁ and 312₂ are not explicitly depicted in FIG. 3, it is apparent from the figure that the device interface ports 312 of the host 315 might be numbered consecutively from device interface port 312₀ to device interface port 312_{P}. Furthermore, although read and write paths 352₁, 354₁, 352₂, and 354₂ are not explicitly depicted in FIG. 3, it is apparent from the figure that the read paths 352 might be numbered consecutively from read path 352₀ to read path 352_{P}, and that the write paths 354 might be numbered consecutively from write path 354₀ to write path 354_{P}.

Each read path 352 might have a structure as described with respect to the read path 252 of FIG. 2 and each write path 354 might have a structure as described with respect to the write path 254 of FIG. 2. Similar to the situations described with reference to FIG. 2, each read path 352 might share communication signal lines with its corresponding write path 354.

Commands and other control signals, and/or data, might be communicated between the device interface ports 312 of the host 315 and the input interface 332 of the managed memory controller 305 through the corresponding host interface ports 330. The communications of the managed memory controller 305 over the input/output (I/O) paths (e.g., the read paths 352 and write paths 354) with the host 315 might be according to a protocol such as, for example, Peripheral Component Interconnect Express (PCIe). The managed memory controller 305 might further utilize a communication protocol such as the Compute Express Link™ (CXL) protocol to communicate with the host 315 such that the managed memory controller 305 might be regarded as a “CXL Controller.”

The memory expansion module 310 might be a Compute Express Link™ (CXL) compliant memory system (e.g., the memory system can include a PCIe/CXL interface). CXL is a high-speed central processing unit (CPU)-to-device and CPU-to-memory interconnect designed to accelerate next-generation data center performance. CXL technology maintains memory coherency between the CPU memory space and memory on attached devices, which allows resource sharing for higher performance, reduced software stack complexity, and lower overall system cost. CXL is designed to be an industry open standard interface for high-speed communications, as accelerators are increasingly used to complement CPUs in support of emerging applications such as artificial intelligence and machine learning.

CXL technology is built on the peripheral component interconnect express (PCIe) infrastructure, leveraging PCIe physical and electrical interfaces to provide advanced protocol in areas such as I/O protocol, memory protocol (e.g., initially allowing a host 315 to share memory with an accelerator), and coherency interface. When the managed memory controller 305 is CXL compliant, the processing circuitry of the managed memory controller 305 might use CXL protocols to manage the host interface ports 330.

The communications over the read paths 352 and write paths 354 of each host interface port 330 to the host 315 might include commands and/or control signals such as back pressure commands and/or control signals indicating to the host 315 a desire to pause the transmission of new read and/or write commands to the corresponding host interface port 330 of the managed memory controller 305. These commands and/or control signals might reduce or completely stop data traffic such as read and/or write commands from being transmitted from the host 315 to one or more host interface ports 330 of the managed memory controller 305. The host interface ports 330 might include interface management circuitry including data link and transaction control which might provide higher layer protocol support for communications with the host 315 through the host interface ports 330.

The input interface 332 might communicate commands, control signals and/or data to the host 315 through the host interface ports 330. The input interface 332 might handle input indication protocol and manage back pressure to the host 315. The input interface 332 might also be in communication with the read buffer 334, the write buffer 336, and a central controller 356. The central controller 356 might include the functionality as described with reference to the read command FIFO 238, the write command FIFO 240, the execution arbiter 242, the execution machine 244, and the transfer manager 246 of FIG. 2 for each read path 352 and write path 354. The central controller 356 might further be in communication with a cache memory 348 and a plurality of dynamic memory controllers 350, e.g., dynamic memory controllers 350₀-350_{P}. The input interface 332 might communicate control signals and data with each of the read buffer 334 and the write buffer 336 via corresponding control signal lines and data bus lines (e.g., see legend in FIG. 2). The central controller 356 might further include storage registers 358 which might represent computer-usable memory for storing computer-readable instructions and/or other data, such as various thresholds for use with embodiments. For some embodiments, the storage registers 358 might represent firmware. For other embodiments, the storage registers 358 might represent volatile or non-volatile storage elements, or a combination of firmware and storage elements. The central controller 356 might be configured to cause the managed memory controller 305, e.g., to cause relevant components of the managed memory controller 305, to perform methods according to various embodiments, e.g., through execution of computer-readable instructions stored to the storage registers 358.

The read buffer 334 might store data received from the cache memory 348 and/or the memory devices 100 through the central controller 356 as a result of the execution of a read command by the managed memory controller 305. The read buffer 334 might also serve incoming read commands. The read buffer 334 might include a number (e.g., 64, a multiple of 64, or other number) of entries, each of which might correspond to a read command.

A determination might be made regarding whether or not the read buffer 334 is fully allocated, that is, whether or not the capacity of the read buffer 334 for serving read commands has been completely reserved (e.g., all entries of the read buffer 334 are allocated). In response to a determination that the read buffer 334 is fully allocated, the managed memory controller 305 might indicate to the host 315, e.g., via asserted back pressure for read commands, that a flow of new incoming read commands should be paused.

The write buffer 336 might communicate data to the cache memory 348 and/or the memory devices 100 through the central controller 356 such that the data (e.g., data received from the host 315) might be written to the cache memory 348 and/or the memory devices 100 as a result of the execution of a write command by the managed memory controller 305. The write buffer 336 might also serve incoming write commands. The write buffer 336 might include a number (e.g., 64, a multiple of 64, or other number, which might be the same number as the read buffer 334) of entries, each of which might correspond to a write command.

A determination might be made regarding whether or not the write buffer 336 is fully allocated, that is, whether or not the capacity of the write buffer 336 for serving write commands has been completely reserved (e.g., all entries of the write buffer 336 are allocated). In response to a determination that the write buffer 336 is fully allocated, the managed memory controller 305 might indicate to the host 315, e.g., via asserted back pressure for write commands, that a flow of new incoming write commands should be paused.

A number of entries allocated in the write buffer 336 for serving corresponding write commands might also be added to a number of entries allocated in the read buffer 334 for serving corresponding read commands to determine a total number of allocated buffer entries of the managed memory controller 305, e.g., in the read buffer 334 and the write buffer 336. The total number of allocated buffer entries in the read buffer 334 and the write buffer 336 might be used for comparison to a first threshold (“MNAB_TH”) in a process for determining whether new incoming read commands and/or write commands can be requested or accepted by the managed memory controller 305, regardless of whether the read buffer 334 and/or the write buffer 336 are fully allocated.

The first threshold might be a defined (e.g., predefined) number of allocated buffer entries. Alternatively, the number of entries allocated to the read buffer 334 and the write buffer 336 might be used in a process for determining whether the managed memory controller 305 should indicate to the host 315, e.g., via asserted back pressure for read commands and/or write commands, that a flow of new incoming read commands and/or write commands, respectively, should be paused. The specific value of the first threshold MNAB_TH might be configurable and might be determined at least based on the amount of expected read and write traffic to the memory devices 100 and/or the size of the cache memory 348.

The dynamic memory controllers 350 of the managed memory controller 305 might be configured to communicate with one or more types of memory devices 100 (e.g., DRAM devices) through a plurality of channels, including control signal lines and data bus lines, which can be used to read/write data to/from the memory devices, to transmit commands to the memory devices, to receive status and statistics from the memory devices, etc., including command and data.

Each dynamic memory controller 350 might be in communication with a respective set of memory devices 100. For example, the dynamic memory controller 350₀ might be in communication with memory devices 100₀₀ to 100_{0D} and the dynamic memory controller 350_{P} might be in communication with memory devices 100_{P0} to 100_{PD}. The value of D might be an integer value greater than or equal to one. Although each dynamic memory controller 350 is depicted to be in communication with a same number of memory devices 100, other embodiments could use different numbers of memory devices 100 in communication with different dynamic memory controllers 350.

The number of read and write commands maintained by the managed memory controller 305 and serviced by the read buffer 334 and the write buffer 336 might be controlled by asserting back pressure on the host 315 to pause the flow of new incoming read and/or write commands, respectively, even if there is space available (e.g., unallocated buffer entries) inside of the read buffer 334 and/or the write buffer 336. Back pressure to pause the flow of new incoming read commands might further be asserted in response to the read buffer 334 being fully allocated, and back pressure to pause the flow of new incoming write commands might further be asserted in response to the write buffer 336 being fully allocated.

Processing a read command received from the host 315 might include performing a read operation on a memory device 100 containing the requested data, and transferring the read data to the host 315. The memory device 100 on which the read operation is performed might be in communication with the dynamic memory controller 350 corresponding to the host interface port 330 that received the read command. For example, the dynamic memory controller 350ᵢ might correspond to the host interface port 330ᵢ, where i is any integer value from 0 to P. Processing a write command received from the host 315 might include performing a write operation to store data received from the host 315 to a memory device 100 addressed by the host 315. The memory device 100 upon which the write operation is performed might be in communication with the dynamic memory controller 350 corresponding to the host interface port 330 that received the write command and its associated data.

Unlike the single-port managed memory controller of the related art described with reference to FIG. 2, multi-port managed memory controllers might present challenges related to differences between the command rate for the different ports as well as differences between read/write ratios for the different ports. As such, the decision whether to apply back pressure can become more complicated.

Various embodiments include read buffer 334 and write buffer 336 that might each contain a plurality of subsets of fixed buffer entries and a subset of dynamic buffer entries. The buffer entries of each subset of fixed buffer entries might be reserved for allocation by (e.g., solely for allocation by) a respective host interface port 330 of a plurality of host interface ports 330₀-330_{P} of a managed memory controller 305, while the buffer entries of the subset of dynamic buffer entries might be available for allocation by any host interface port 330 of the plurality of host interface ports 330₀-330_{P} of the managed memory controller 305. The combination of subsets of fixed buffer entries and a subset of dynamic buffer entries for the read buffer 334 and the write buffer 336 facilitates a process for determining whether back pressure should be applied on a port-by-port basis, and on a path-by-path basis.

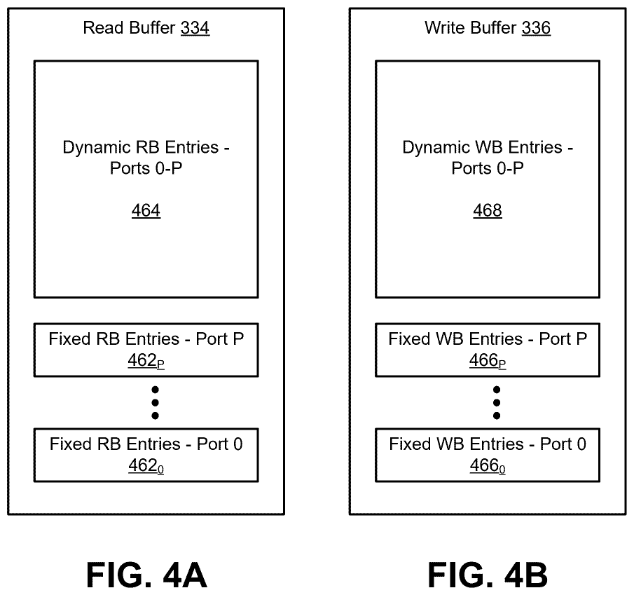

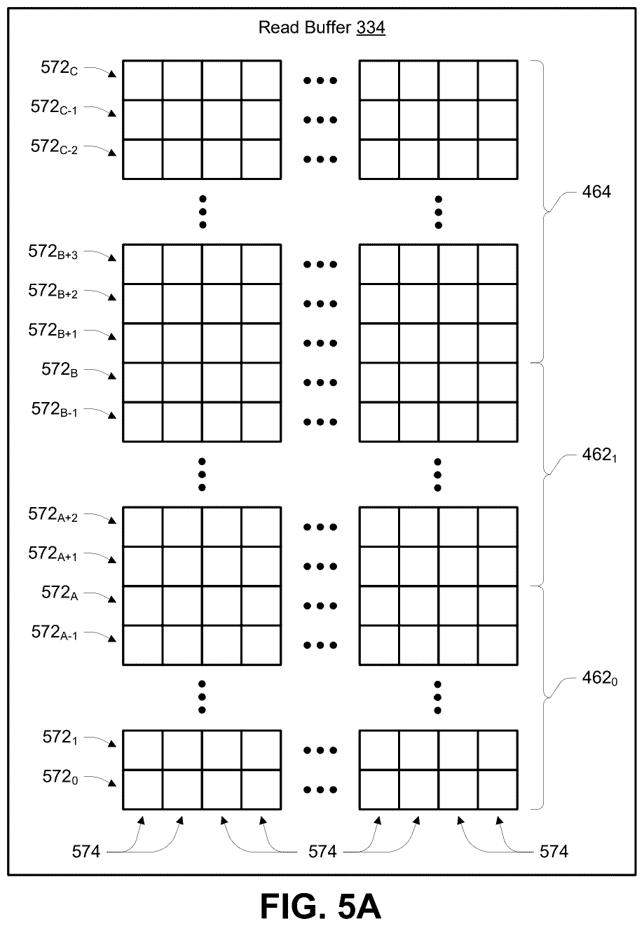

FIG. 4A is a block schematic of a read buffer 334 in accordance with an embodiment. The read buffer 334 might include a plurality of subsets of fixed read buffer entries 462, e.g., the subsets of fixed read buffer entries 462₀-462_{P}. Each subset of fixed read buffer entries 462 of the read buffer 334 might correspond to a corresponding host interface port 330 of the managed memory controller 305. For example, the subset of fixed read buffer entries 462₀ of the read buffer 334 might correspond to the host interface port 330₀ of the managed memory controller 305, the subset of fixed read buffer entries 462₁ of the read buffer 334 might correspond to the host interface port 330₁ of the managed memory controller 305, the subset of fixed read buffer entries 462₂ of the read buffer 334 might correspond to the host interface port 330₂ of the managed memory controller 305, and so on. Although subsets of fixed read buffer entries 462₁ and 462₂ are not explicitly depicted in FIG. 4A, it is apparent from the figure that the subsets of fixed read buffer entries 462 of the read buffer 334 might be numbered consecutively from subset of fixed read buffer entries 462₀ to subset of fixed read buffer entries 462_{P}. Each subset of fixed read buffer entries 462 might be reserved for allocation by (e.g., solely for allocation by) its corresponding host interface port 330 in response to a respective read command received at its corresponding host interface port 330.

The read buffer 334 might further include a subset of dynamic read buffer entries 464. The subset of dynamic read buffer entries 464 might be available for allocation by any host interface port 330 of the managed memory controller 305, e.g., any to all host interface ports 330₀-330_{P}. For some embodiments, allocations for a given host interface port 330 in response to received read commands might be from its corresponding subset of fixed read buffer entries 462 until that is fully allocated, and then from the subset of dynamic read buffer entries 464. Allocated read buffer entries might be released, e.g., unallocated, in response to execution of the corresponding read commands.

FIG. 4B is a block schematic of a write buffer 336 in accordance with an embodiment. The write buffer 336 might include a plurality of subsets of fixed write buffer entries 466, e.g., the subsets of fixed write buffer entries 466₀-466_{P}. Each subset of fixed write buffer entries 466 of the write buffer 336 might correspond to a corresponding host interface port 330 of the managed memory controller 305. For example, the subset of fixed write buffer entries 466₀ of the write buffer 336 might correspond to the host interface port 330₀ of the managed memory controller 305, the subset of fixed write buffer entries 466₁ of the write buffer 336 might correspond to the host interface port 330₁ of the managed memory controller 305, the subset of fixed write buffer entries 466₂ of the write buffer 336 might correspond to the host interface port 330₂ of the managed memory controller 305, and so on. Although subsets of fixed write buffer entries 466₁ and 466₂ are not explicitly depicted in FIG. 4B, it is apparent from the figure that the subsets of fixed write buffer entries 466 of the write buffer 336 might be numbered consecutively from subset of fixed write buffer entries 466₀ to subset of fixed write buffer entries 466_{P}. Each subset of fixed write buffer entries 466 might be reserved for allocation by (e.g., solely for allocation by) its corresponding host interface port 330 in response to a respective write command received at its corresponding host interface port 330.

The write buffer 336 might further include a subset of dynamic write buffer entries 468. The subset of dynamic write buffer entries 468 might be available for allocation by any host interface port 330 of the managed memory controller 305, e.g., any to all host interface ports 330₀-330_{P}. For some embodiments, allocations for a given host interface port 330 in response to received write commands might be from its corresponding subset of fixed write buffer entries 466 until that is fully allocated, and then from the subset of dynamic write buffer entries 468. Allocated write buffer entries might be released, e.g., unallocated, in response to execution of the corresponding write commands.

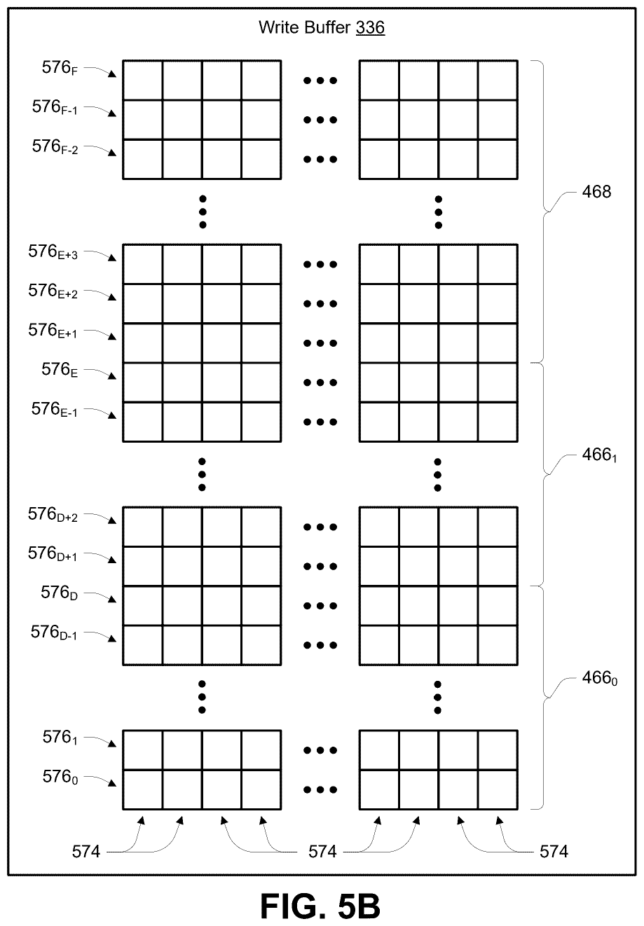

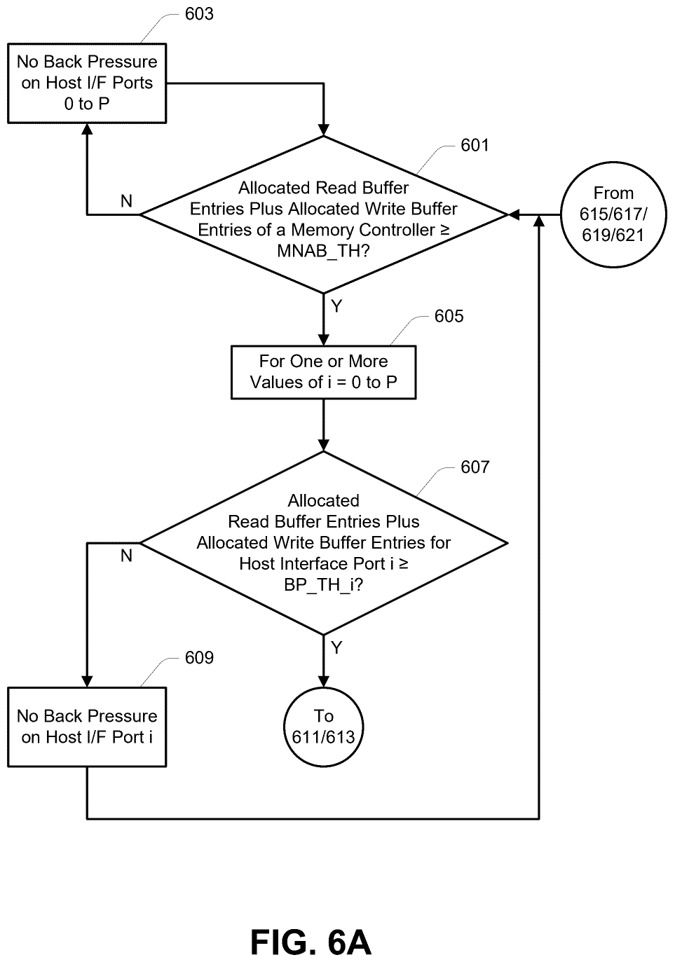

FIGS. 5A and 5B provide additional detail of a read buffer 334 and write buffer 336 such as the type depicted FIGS. 4A and 4B, respectively. In particular, FIGS. 5A and 5B consider the case of P=1.

FIG. 5A is a block schematic of a read buffer 334 in accordance with a further embodiment. The read buffer 334 might include C+1 read buffer entries 572, e.g., read buffer entries 572₀-572_{C}, where C is an integer value. Each read buffer entry 572 might include a plurality of digit registers 574 for storage of one or more digits of data to each digit register 574.

Considering the case of P=1, the read buffer 334 might include two subsets of fixed read buffer entries 462, e.g., the subsets of fixed read buffer entries 462₀ and 462₁, and the subset of dynamic read buffer entries 464. The subset of fixed read buffer entries 462₀ might include read buffer entries 572₀ to 572_{A}, the subset of fixed read buffer entries 462₁ might include read buffer entries 572_{A+1} to 572_{B}, and the subset of dynamic read buffer entries 464 might include read buffer entries 572_{B+1} to 572_{C}.

The values of A and B might further be integer values each greater than or equal to one, and less than C. For some embodiments, subsets of fixed read buffer entries 462 corresponding to each of the host interface ports 330 of a managed memory controller 305 might contain a same number of read buffer entries 572. In such a case, the values of A and B in FIG. 5A might satisfy the condition of A+1=B−A, or simplified as B=2*A+1. For some embodiments, the subset of dynamic read buffer entries 464 might contain a greater number of read buffer entries 572 than each subset of fixed buffer entries 462. In such a case, C-B might be greater than B-A and greater than A+1 in the example of FIG. 5A. The subset of dynamic read buffer entries 464 might further contain a greater number of read buffer entries 572 than a sum of read buffer entries 572 for all subsets of fixed buffer entries 462. In such a case, C-B might be greater than B+1 in the example of FIG. 5A.

Although the subsets of fixed read buffer entries 462 and the subset of dynamic read buffer entries 464 are each depicted to contain a contiguous grouping of read buffer entries 572, this is not required. For example, the read buffer entries 572 for each of the subsets of fixed read buffer entries 462, and for the subset of dynamic read buffer entries 464, could be interspersed between read buffer entries 572 of other subsets of read buffer entries. In addition, the term subset of fixed read buffer entries 462, as used herein, does not indicate that its read buffer entries 572 are fixed in location. Instead, the term indicates that its read buffer entries 572 are reserved for allocation for its corresponding host interface port 330 in response to respective read commands received at its corresponding host interface port 330. Similarly, the term subset of dynamic read buffer entries 464, as used herein, does not require that its read buffer entries 572 are dynamic in location. Instead, the term indicates that its read buffer entries 572 are available for allocation for any of the host interface ports 330 in response to respective read commands.

FIG. 5B is a block schematic of a write buffer 336 in accordance with a further embodiment. The write buffer 336 might include F+1 write buffer entries 576, e.g., write buffer entries 576₀-576_{F}, where F is an integer value. Each write buffer entry 576 might include a plurality of digit registers 574 for storage of one or more digits of data to each digit register 574.

Considering the case of P=1, the write buffer 336 might include two subsets of fixed write buffer entries 466, e.g., the subsets of fixed write buffer entries 466₀ and 466₁, and the subset of dynamic write buffer entries 468. The subset of fixed write buffer entries 466₀ might include write buffer entries 576₀ to 576_{D}, the subset of fixed write buffer entries 466₁ might include write buffer entries 576_{D+1} to 576_{E}, and the subset of dynamic write buffer entries 468 might include write buffer entries 576_{E+1} to 576_{F}.

The values of D and E might further be integer values each greater than or equal to one, and less than F. For some embodiments, subsets of fixed write buffer entries 466 corresponding to each of the host interface ports 330 of a managed memory controller 305 might contain a same number of write buffer entries 576. In such a case, the values of D and E in FIG. 5B might satisfy the condition of D+1=E-D, or simplified as E=2*D+1. For some embodiments, the subset of dynamic write buffer entries 468 might contain a greater number of write buffer entries 576 than each subset of fixed buffer entries 466. In such a case, F-E might be greater than E-D and greater than D+1 in the example of FIG. 5B. The subset of dynamic write buffer entries 468 might further contain a greater number of write buffer entries 576 than a sum of write buffer entries 576 for all subsets of fixed buffer entries 466. In such a case, F-E might be greater than E+1 in the example of FIG. 5B.

Although the subsets of fixed write buffer entries 466 and the subset of dynamic write buffer entries 468 are each depicted to contain a contiguous grouping of write buffer entries 576, this is not required. For example, the write buffer entries 576 for each of the subsets of fixed write buffer entries 466, and for the subset of dynamic write buffer entries 468, could be interspersed between write buffer entries 576 of other subsets of write buffer entries. In addition, the term subset of fixed write buffer entries 466, as used herein, does not indicate that its write buffer entries 576 are fixed in location. Instead, the term indicates that its write buffer entries 576 are reserved for allocation for its corresponding host interface port 330 in response to respective write commands received at its corresponding host interface port 330. Similarly, the term subset of dynamic write buffer entries 468, as used herein, does not require that its write buffer entries 576 are dynamic in location. Instead, the term indicates that its write buffer entries 576 are available for allocation for any of the host interface ports 330 in response to respective write commands.

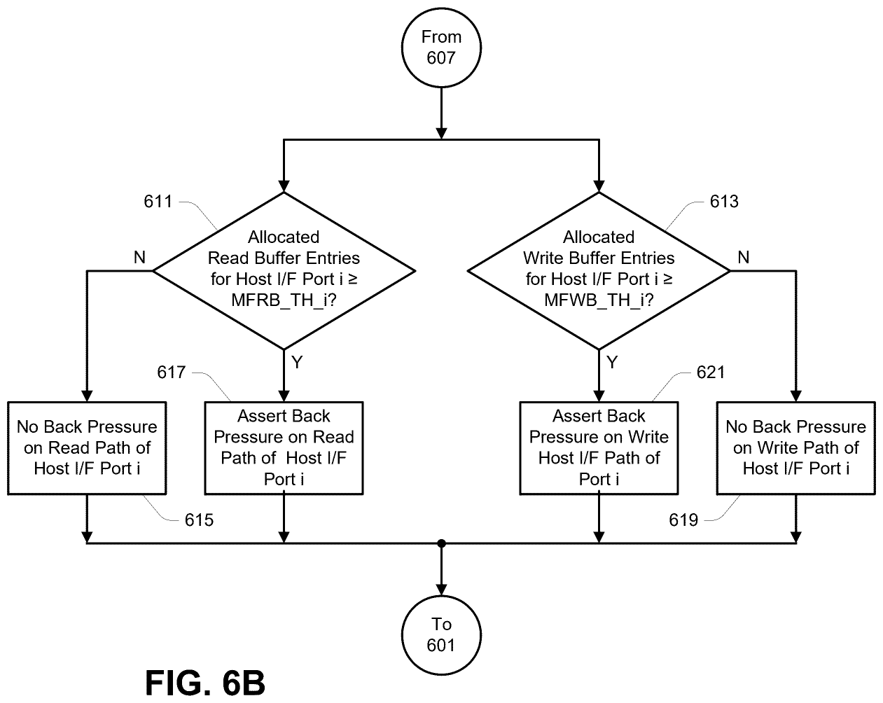

FIGS. 6A-6B are a flowchart of a method of operating a managed memory controller 305 in accordance with an embodiment. The method might represent actions associated with regulating the intake of read and write commands by the managed memory controller 305, e.g., pausing or accepting the intake of read and write commands at one or more host interface ports 330 of the managed memory controller 305. The method might be in the form of computer-readable instructions, e.g., stored to the storage registers 358. Such computer-readable instructions might be executed by a controller, e.g., the central controller 356, to cause the relevant components of the managed memory controller 305 to perform the method.

At 601, the managed memory controller 305 might determine whether a number of allocated read buffer entries 572 (e.g., fixed and/or dynamic read buffer entries 572) plus allocated write buffer entries 576 (e.g., fixed and/or dynamic write buffer entries 576) of the managed memory controller 305 is greater than or equal to a first threshold MNAB_TH. The first threshold MNAB_TH might be equal to a defined (e.g., predefined) desired maximum number of allocated buffer entries 572/576 for the managed memory controller 305, and might be a number that is less than a total number of buffer entries 572/576 available to the managed memory controller 305. For example, with reference to FIGS. 5A and 5B, the first threshold MNAB_TH might be less than (C+1)+(F+1). A number of read buffer entries 572 (e.g., 572₀-572_{C}) that are allocated to any of the host interface ports 330 plus a number of write buffer entries 576 (e.g., 576₀-576_{F}) that are allocated to any of the host interface ports 330 might be compared to the first threshold MNAB_TH to determine whether a total number of allocated buffer entries 572/576 is greater than or equal to MNAB_TH. If not, the managed memory controller 305 might not assert back pressure on any host interface port 330 at 603, and the process might return to 601. Otherwise, the process might proceed to 605.

At 605, the process of 607-621 might be repeated for one or more values of i=0 to P, e.g., for one or more host interface ports 330 (e.g., 330₀-330_{P}) of the managed memory controller 305. The process of 607-621 might be repeated until the number of allocated read buffer entries 572 plus allocated write buffer entries 576 of the managed memory controller 305 is less than the first threshold MNAB_TH. The process of 607-621 might further be repeated for each value of i=0 to P. Repeating the process of 607-621 for more than host interface port 330 might be performed concurrently or sequentially. It is noted that the process of 607-621 for any host interface port 330 might be terminated prior to completion in response to the number of allocated read buffer entries 572 plus allocated write buffer entries 576 of the managed memory controller 305 decreasing to a number that is less than the first threshold MNAB_TH.

At 607, the managed memory controller 305 might determine whether a number of allocated read buffer entries 572 (e.g., fixed and/or dynamic read buffer entries 572) plus allocated write buffer entries 576 (e.g., fixed and/or dynamic write buffer entries 576) for host interface port 330ᵢ is greater than or equal to a second threshold BP_TH_i. The second threshold BP_TH_i might be equal to a defined (e.g., predefined) desired maximum number of allocated buffer entries 572/576 for the managed memory controller 305 to be allocated to the host interface port 330ᵢ at 607 (e.g., having satisfied the condition at 601), and might be a number that is less than a total number of fixed buffer entries 572/576 and dynamic buffer entries 572/576 available to the host interface port 330ᵢ of the managed memory controller 305. For example, with reference to FIGS. 5A and 5B, the second threshold BP_TH_i might be less than (A+1)+(C−B)+(D+1)+(F−E) for i=0. Note that respective values of the second threshold BP_TH_i might be the same or different for different values of i, e.g., one host interface port 330 might have a same second threshold as one or more other host interface ports 330, and/or it might have a different second threshold than one or more other host interface ports 330. A number of read buffer entries 572 that are allocated to the host interface port 330ᵢ plus a number of write buffer entries 576 that are allocated to the host interface port 330ᵢ might be compared to the second threshold BP_TH_i to determine whether a total number of allocated buffer entries 572/576 for the host interface port 330ᵢ is greater than or equal to BP_TH_i. If not, the managed memory controller 305 might not assert back pressure on the host interface port 330ᵢ at 609, and the process might return to 601. Otherwise, the process might proceed to 611 and 613.

At 611, the managed memory controller 305 might determine whether a number of allocated read buffer entries 572 (e.g., fixed and/or dynamic read buffer entries 572) for host interface port 330ᵢ is greater than or equal to the third threshold MFRB_TH_i. The third threshold MFRB_TH_i might be equal to a defined (e.g., predefined) desired maximum number of allocated read buffer entries 572 for the managed memory controller 305 to be allocated to the host interface port 330ᵢ at 611 (e.g., having satisfied the conditions at 601 and 607), and might be a number that is less than a total number of fixed read buffer entries 572 and dynamic read buffer entries 572 available to the host interface port 330ᵢ of the managed memory controller 305. For example, with reference to FIG. 5A, the third threshold MFRB_TH_i might be less than (A+1)+(C−B) for i=0. Note that respective values of the third threshold MFRB_TH_i might be the same or different for different values of i, e.g., one host interface port 330 might have a same third threshold as one or more other host interface ports 330, and/or it might have a different third threshold than one or more other host interface ports 330. A number of read buffer entries 572 that are allocated to the host interface port 330ᵢ might be compared to the third threshold MFRB_TH_i to determine whether a total number of allocated read buffer entries 572 for the host interface port 330ᵢ is greater than or equal to MFRB_TH_i. If not, the managed memory controller 305 might not assert back pressure on a read path of the host interface port 330ᵢ at 615. Otherwise, the managed memory controller 305 might assert back pressure on the read path of the host interface port 330ᵢ at 617. Asserting back pressure on the read path of the host interface port 330ᵢ might include communicating a desire to the host 315 to pause submitting read commands to the host interface port 330ᵢ, and thus to pause submitting requests to read data from any of the memory devices 100 in communication with the dynamic memory controller 350 corresponding to the host interface port 330ᵢ. The process might then return to 601 from 611.

At 613, the managed memory controller 305 might determine whether a number of allocated write buffer entries 576 (e.g., fixed and/or dynamic write buffer entries 576) for host interface port 330ᵢ is greater than or equal to the fourth threshold MFWB_TH_i. The fourth threshold MFWB_TH_i might be equal to a defined (e.g., predefined) desired maximum number of allocated write buffer entries 576 for the managed memory controller 305 to be allocated to the host interface port 330ᵢ at 613 (e.g., having satisfied the conditions at 601 and 607), and might be a number that is less than a total number of fixed write buffer entries 576 and dynamic write buffer entries 576 available to the host interface port 330ᵢ of the managed memory controller 305. For example, with reference to FIG. 5B, the fourth threshold MFWB_TH_i might be less than (D+1)+(F−E) for i=0. Note that respective values of the fourth threshold MFWB_TH_i might be the same or different for different values of i, e.g., one host interface port 330 might have a same fourth threshold as one or more other host interface ports 330, and/or it might have a different fourth threshold than one or more other host interface ports 330. A number of write buffer entries 576 that are allocated to the host interface port 330ᵢ might be compared to the fourth threshold MFWB_TH_i to determine whether a total number of allocated write buffer entries 576 for the host interface port 330ᵢ is greater than or equal to MFWB_TH_i. If not, the managed memory controller 305 might not assert back pressure on a write path of the host interface port 330ᵢ at 619. Otherwise, the managed memory controller 305 might assert back pressure on the write path of the host interface port 330ᵢ at 621. Asserting back pressure on the write path of the host interface port 330ᵢ might include communicating a desire to the host 315 to pause submitting write commands to the host interface port 330ᵢ, and thus to pause submitting requests to write data to any of the memory devices 100 in communication with the dynamic memory controller 350 corresponding to the host interface port 330ᵢ. The process might then return to 601 from 613.

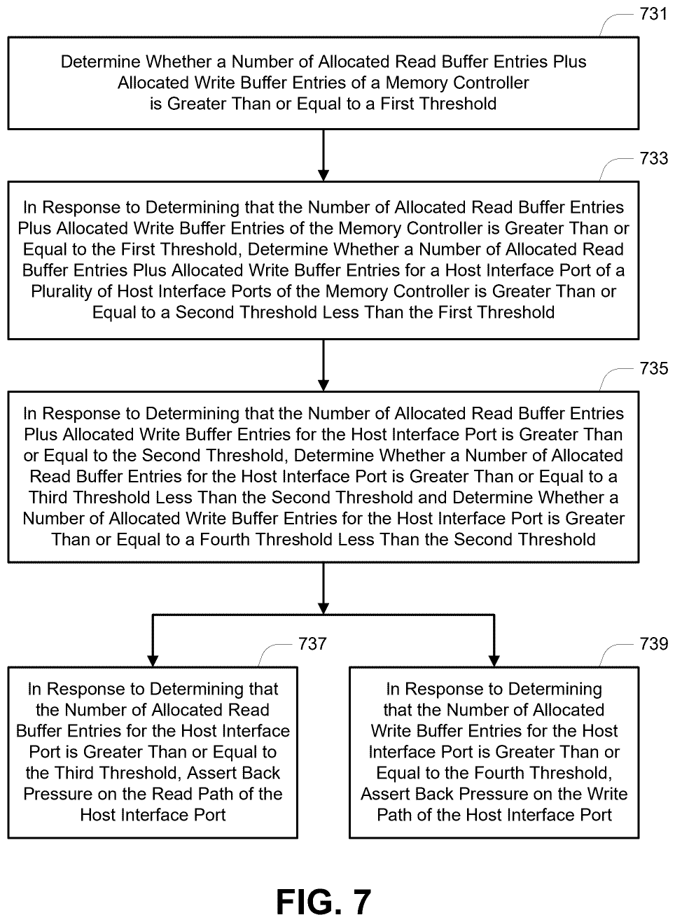

FIG. 7 is a flowchart of a method of operating a managed memory controller 305 in accordance with a further embodiment. The method might represent actions associated with regulating the intake of read and write commands by the managed memory controller 305, e.g., pausing or accepting the intake of read and write commands at one or more host interface ports 330 of the managed memory controller 305. The method might be in the form of computer-readable instructions, e.g., stored to the storage registers 358. Such computer-readable instructions might be executed by a controller, e.g., the central controller 356, to cause the relevant components of the managed memory controller 305 to perform the method.

At 731, the managed memory controller 305 might determine whether a number of allocated read buffer entries 572 (e.g., fixed and/or dynamic read buffer entries 572) plus allocated write buffer entries 576 (e.g., fixed and/or dynamic write buffer entries 576) of the managed memory controller 305 is greater than or equal to a first threshold. For example, the total number of read buffer entries 572 of the read buffer 334 and write buffer entries 576 of the write buffer 336 that are allocated to any host interface port 330 might be compared to the first threshold (e.g., MNAB_TH) to determine whether it is greater than or equal to the first threshold.

At 733, in response to determining that the number of allocated read buffer entries 572 plus allocated write buffer entries 576 of the managed memory controller 305 is greater than or equal to the first threshold, the managed memory controller 305 might determine whether a number of allocated read buffer entries 572 (e.g., fixed and/or dynamic read buffer entries 572) plus allocated write buffer entries 576 (e.g., fixed and/or dynamic write buffer entries 576) for a (e.g., one) host interface port (e.g., a host interface port 330ᵢ) of a plurality of host interface ports 330 (e.g., 330₀-330_{P}, where i is any integer value 0 to P) of the managed memory controller 305 is greater than or equal to a second threshold less than the first threshold. For example, the total number of read buffer entries 572 of the read buffer 334 and write buffer entries 576 of the write buffer 336 that are allocated to the host interface port might be compared to the second threshold (e.g., BP_TH_i for a host interface port 330ᵢ) to determine whether it is greater than or equal to the second threshold.

At 735, in response to determining that the number of allocated read buffer entries 572 plus allocated write buffer entries 576 for the host interface port is greater than or equal to the second threshold, the managed memory controller 305 might determine whether a number of allocated read buffer entries 572 (e.g., fixed and/or dynamic read buffer entries 572) for the host interface port is greater than or equal to a third threshold less than the second threshold, and might determine whether a number of allocated write buffer entries 576 (e.g., fixed and/or dynamic write buffer entries 576) for the host interface port is greater than or equal to a fourth threshold less than the second threshold. For example, the total number of read buffer entries 572 of the read buffer 334 that are allocated to the host interface port might be compared to the third threshold (e.g., MFRB_TH_i for a host interface port 330ᵢ) to determine whether it is greater than or equal to the third threshold and the total number of write buffer entries 576 of the write buffer 336 that are allocated to the host interface port might be compared to the fourth threshold (e.g., MFWB_TH_i for a host interface port 330ᵢ) to determine whether it is greater than or equal to the fourth threshold.

At 737, in response to determining that the number of allocated read buffer entries 572 for the host interface port is greater than or equal to the third threshold, the managed memory controller 305 might assert back pressure on a read path 352 of the host interface port. In response to determining that the number of allocated read buffer entries 572 and allocated write buffer entries 576 of the managed memory controller 305 is less than the first threshold, that the number of allocated read buffer entries 572 and allocated write buffer entries 576 for the host interface port is less than the second threshold, or that the number of allocated read buffer entries 572 for the host interface port is less than the third threshold, the managed memory controller 305 might de-assert back pressure on a read path 352 of the host interface port. De-asserting back pressure on the read path 352 of a host interface port 330 might include communicating to the host 315 that the managed memory controller 305 is available to receive additional read commands at that host interface port 330. Alternatively, the host 315 might have a default condition that if back pressure is not asserted on the read path 352 of a host interface port 330, e.g., the managed memory controller 305 is not actively providing a control signal indicative of a desire to pause read commands to that host interface port 330, the managed memory controller 305 is available to accept read commands to that host interface port 330. In such an embodiment, de-asserting back pressure on the read path 352 of that host interface port 330 might include not indicating a desire to pause read commands to that host interface port 330.

At 739, in response to determining that the number of allocated write buffer entries 576 for the host interface port is greater than or equal to the fourth threshold, the managed memory controller 305 might assert back pressure on a write path 354 of the host interface port. In response to determining that the number of allocated read buffer entries 572 plus allocated write buffer entries 576 of the managed memory controller 305 is less than the first threshold, that the number of allocated read buffer entries 572 plus allocated write buffer entries 576 for the host interface port is less than the second threshold, or that the number of allocated write buffer entries 576 for the host interface port is less than the fourth threshold, the managed memory controller 305 might de-assert back pressure on the write path 354 of the host interface port. De-asserting back pressure on the write path 354 of the host interface port might include communicating to the host 315 that the managed memory controller 305 is available to receive additional write commands at the host interface port. Alternatively, the host 315 might have a default condition that if back pressure is not asserted on the write path 354 of a host interface port 330, e.g., the managed memory controller 305 is not actively providing a control signal indicative of a desire to pause write commands to that host interface port 330, the managed memory controller 305 is available to accept write commands to that host interface port 330. In such an embodiment, de-asserting back pressure on the write path 354 of that host interface port 330 might include not indicating a desire to pause write commands to that host interface port 330.

The process of FIG. 7 might be repeated for each host interface port 330 of the plurality of host interface ports 330. The process of 733 to 737/739 might be repeated for each host interface port 330 either sequentially or concurrently. It is noted that the process of FIG. 7 for any host interface port 330 might be terminated prior to completion in response to the number of allocated read buffer entries 572 plus allocated write buffer entries 576 of the managed memory controller 305 decreasing to a number that is less than the first threshold. Alternatively, the process of FIG. 7 might be completed for each host interface port 330 of the plurality of host interface ports 330 in response to determining that the number of allocated read buffer entries 572 plus allocated write buffer entries 576 of the managed memory controller 305 is greater than or equal to the first threshold at 731.

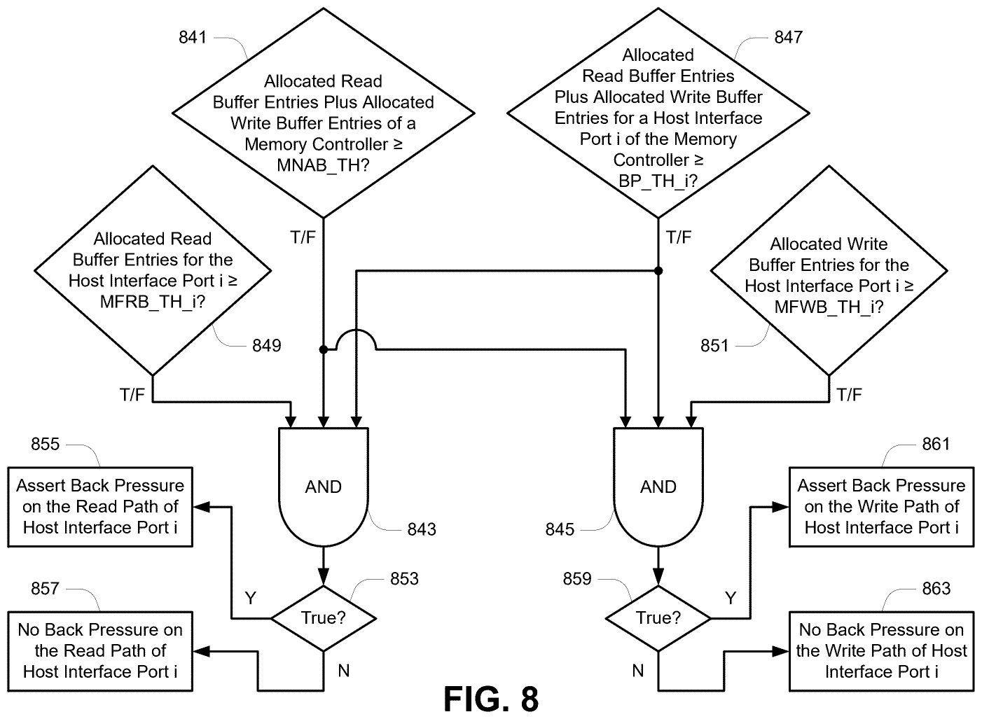

FIG. 8 is a flowchart of a method of operating a managed memory controller in accordance with an embodiment. The method might represent actions associated with regulating the intake of read and write commands by the managed memory controller 305, e.g., pausing or accepting the intake of read and write commands at one or more host interface ports 330 of the managed memory controller 305. The method might be in the form of computer-readable instructions, e.g., stored to the storage registers 358. Such computer-readable instructions might be executed by a controller, e.g., the central controller 356, to cause the relevant components of the managed memory controller 305 to perform the method.

At 841, the managed memory controller 305 might determine whether a number of the allocated read buffer entries 572 (e.g., fixed and/or dynamic read buffer entries 572) plus the allocated write buffer entries 576 (e.g., fixed and/or dynamic write buffer entries 576) of the managed memory controller 305 is greater than or equal to a first threshold (e.g., MNAB_TH). This might resolve into either a true (e.g., 1) or false (e.g., 0) value provided to a first input of a first AND gate 843 and to a first input of a second AND gate 845.

At 847, the managed memory controller 305 might determine whether a number of the allocated read buffer entries 572 (e.g., fixed and/or dynamic read buffer entries 572) plus the allocated write buffer entries 576 (e.g., fixed and/or dynamic write buffer entries 576) for a host interface port i (e.g., host interface port 330ᵢ) of the managed memory controller 305 is greater than or equal to a second threshold (e.g., BP_TH_i) less than the first threshold. The value of i might be any integer value from 0 to P, where P+1 is equal to a number of host interface ports 330 of the managed memory controller 305. The determination might resolve into either a true (e.g., 1) or false (e.g., 0) value provided to a second input of the first AND gate 843 and to a second input of the second AND gate 845.

At 849, the managed memory controller 305 might determine whether a number of the allocated read buffer entries 572 (e.g., fixed and/or dynamic read buffer entries 572) for the host interface port i of the managed memory controller 305 is greater than or equal to a third threshold (e.g., MFRB_TH_i) less than the second threshold. The determination might resolve into either a true (e.g., 1) or false (e.g., 0) value provided to a third input of the first AND gate 843.

At 851, the managed memory controller 305 might determine whether a number of the allocated write buffer entries 576 (e.g., fixed and/or dynamic write buffer entries 576) for the host interface port i of the managed memory controller 305 is greater than or equal to a fourth threshold (e.g., MFWB_TH_i) less than the second threshold. The determination might resolve into either a true (e.g., 1) or false (e.g., 0) value provided to a third input of the second AND gate 845.7

At 853, the managed memory controller 305 might determine whether the output of the first AND gate 843 is true. If so, the managed memory controller 305 might assert back pressure on a read path of the host interface port i at 855. If not, the managed memory controller 305 might assert no back pressure (e.g., might de-assert back pressure) on the read path of the host interface port i at 857.

At 859, the managed memory controller 305 might determine whether the output of the second AND gate 845 is true. If so, the managed memory controller 305 might assert back pressure on a write path of the host interface port i at 861. If not, the managed memory controller 305 might assert no back pressure (e.g., might de-assert back pressure) on the write path of the host interface port i at 863.

The process of FIG. 8 might be repeated for each host interface port 330 of the plurality of host interface ports 330. The process of 847/849 to 855/857 and the process of 847/851 to 861/863 might be repeated for each host interface port 330 either sequentially or concurrently.

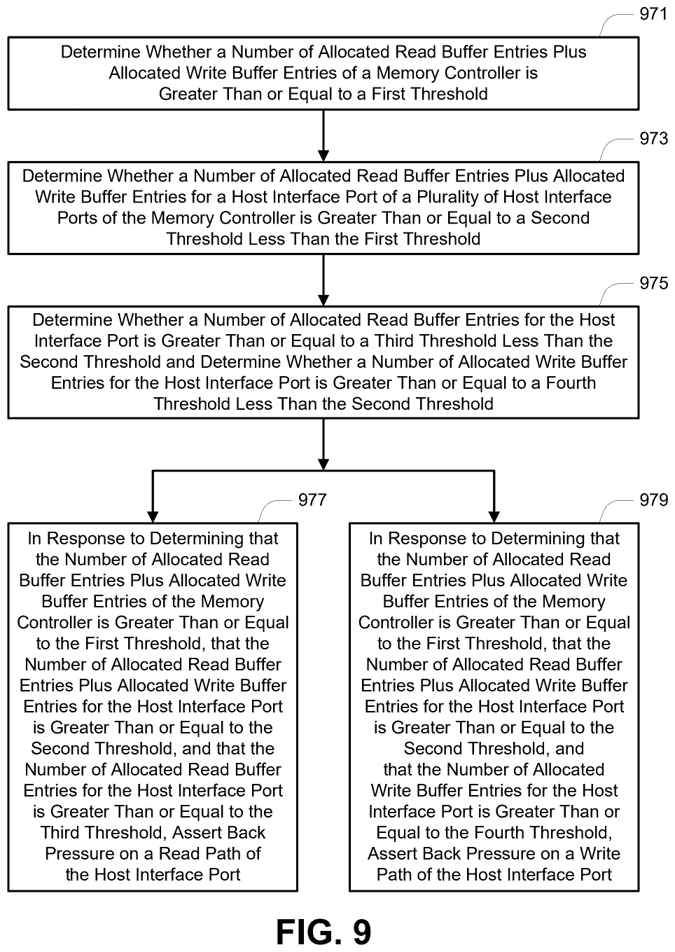

FIG. 9 is a flowchart of a method of operating a managed memory controller in accordance with a further embodiment. The method might represent actions associated with regulating the intake of read and write commands by the managed memory controller 305, e.g., pausing or accepting the intake of read and write commands at one or more host interface ports 330 of the managed memory controller 305. The method might be in the form of computer-readable instructions, e.g., stored to the storage registers 358. Such computer-readable instructions might be executed by a controller, e.g., the central controller 356, to cause the relevant components of the managed memory controller 305 to perform the method.

At 971, the managed memory controller 305 might determine whether a number of allocated read buffer entries 572 (e.g., fixed and/or dynamic read buffer entries 572) plus allocated write buffer entries 576 (e.g., fixed and/or dynamic write buffer entries 576) of the managed memory controller 305 is greater than or equal to a first threshold. For example, the total number of read buffer entries 572 of the read buffer 334 and write buffer entries 576 of the write buffer 336 that are allocated to any host interface port 330 might be compared to the first threshold (e.g., MNAB_TH) to determine whether it is greater than or equal to the first threshold.

At 973, the managed memory controller 305 might determine whether a number of allocated read buffer entries 572 (e.g., fixed and/or dynamic read buffer entries 572) plus allocated write buffer entries 576 (e.g., fixed and/or dynamic write buffer entries 576) for a (e.g., one) host interface port 330 of a plurality of host interface ports 330 (e.g., host interface ports 330₀-330_{P}) of the managed memory controller 305 is greater than or equal to a second threshold less than the first threshold. For example, the total number of read buffer entries 572 of the read buffer 334 and write buffer entries 576 of the write buffer 336 that are allocated to the host interface port 330 (e.g., a host interface port 330ᵢ, where i is any integer value 0 to P) might be compared to the second threshold (e.g., BP_TH_i for a host interface port 330ᵢ) to determine whether it is greater than or equal to the second threshold.

At 975, the managed memory controller 305 might determine whether a number of allocated read buffer entries 572 (e.g., fixed and/or dynamic read buffer entries 572) for the host interface port 330 is greater than or equal to a third threshold less than the second threshold, and might determine whether a number of allocated write buffer entries 576 (e.g., fixed and/or dynamic write buffer entries 576) for the host interface port 330 is greater than or equal to a fourth threshold less than the second threshold. For example, the total number of read buffer entries 572 of the read buffer 334 that are allocated to the host interface port 330 (e.g., a host interface port 330ᵢ) might be compared to the third threshold (e.g., MFRB_TH_i for a host interface port 330ᵢ) to determine whether it is greater than or equal to the third threshold and the total number of write buffer entries 576 of the write buffer 336 that are allocated to the host interface port 330 might be compared to the fourth threshold (e.g., MFWB_TH_i for a host interface port 330ᵢ) to determine whether it is greater than or equal to the fourth threshold.

The determinations whether the number of allocated read buffer entries 572 plus allocated write buffer entries 576 of the managed memory controller 305 is greater than or equal to the first threshold, whether the number of allocated read buffer entries 572 plus allocated write buffer entries 576 for the host interface port 330 is greater than or equal to the second threshold, whether the number of allocated read buffer entries 572 for the host interface port 330 is greater than or equal to the third threshold, and whether the number of allocated write buffer entries 576 for the host interface port 330 is greater than or equal to the fourth threshold, might be made concurrently or sequentially. Furthermore, the managed memory controller 305 might periodically determine how many read buffer entries 572 are allocated for each host interface port 330 and how many write buffer entries 576 are allocated for each host interface port 330. These values could then be stored, e.g., to the storage registers 358, to be used to make the various determinations. The first threshold, second threshold, third threshold, and fourth threshold could also be stored, e.g., to the storage registers 358, for use in the comparisons.

At 977, in response to determining that the number of allocated read buffer entries 572 plus allocated write buffer entries 576 of the managed memory controller 305 is greater than or equal to the first threshold, that the number of allocated read buffer entries 572 plus allocated write buffer entries 576 for the host interface port 330 is greater than or equal to the second threshold, and that the number of allocated read buffer entries 572 for the host interface port 330 is greater than or equal to the third threshold, the managed memory controller 305 might assert back pressure on a read path 352 of the host interface port 330. In response to determining that the number of allocated read buffer entries 572 plus allocated write buffer entries 576 of the managed memory controller 305 is less than the first threshold, that the number of allocated read buffer entries 572 plus allocated write buffer entries 576 for the host interface port 330 is less than the second threshold, or that the number of allocated read buffer entries 572 for the host interface port 330 is less than the third threshold, the managed memory controller 305 might de-assert back pressure on the read path 352 of the host interface port 330. De-asserting back pressure on the read path 352 of the host interface port 330 might include communicating to the host 315 that the managed memory controller 305 is available to receive additional read commands at the host interface port 330. Alternatively, the host 315 might have a default condition that if back pressure is not asserted on the read path 352 of the host interface port 330, e.g., the managed memory controller 305 is not actively providing a control signal indicative of a desire to pause read commands to the host interface port 330, the managed memory controller 305 is available to accept read commands to the host interface port 330. In such an embodiment, de-asserting back pressure on the read path 352 of the host interface port 330 might include not indicating a desire to pause read commands to the host interface port 330.

At 979, in response to determining that the number of allocated read buffer entries 572 plus allocated write buffer entries 576 of the managed memory controller 305 is greater than or equal to the first threshold, that the number of allocated read buffer entries 572 plus allocated write buffer entries 576 for the host interface port 330 is greater than or equal to the second threshold, and that the number of allocated write buffer entries 576 for the host interface port 330 is greater than or equal to the fourth threshold, the managed memory controller 305 might assert back pressure on a write path 354 of the host interface port 330. In response to determining that the number of allocated read buffer entries 572 plus allocated write buffer entries 576 of the managed memory controller 305 is less than the first threshold, that the number of allocated read buffer entries 572 plus allocated write buffer entries 576 for the host interface port 330 is less than the second threshold, or that the number of allocated write buffer entries 576 for the host interface port 330 is less than the fourth threshold, the managed memory controller 305 might de-assert back pressure on the write path 354 of the host interface port 330. De-asserting back pressure on the write path 354 of the host interface port 330 might include communicating to the host 315 that the managed memory controller 305 is available to receive additional write commands at the host interface port 330. Alternatively, the host 315 might have a default condition that if back pressure is not asserted on the write path 354 of the host interface port 330, e.g., the managed memory controller 305 is not actively providing a control signal indicative of a desire to pause write commands to the host interface port 330, the managed memory controller 305 is available to accept write commands to the host interface port 330. In such an embodiment, de-asserting back pressure on the write path 354 of the host interface port 330 might include not indicating a desire to pause write commands to the host interface port 330.

The process of FIG. 9 might be repeated for each host interface port 330 of the plurality of host interface ports 330. The process of 973 to 977/979 might be repeated for each host interface port 330 either sequentially or concurrently. It is noted that the process of FIG. 9 for any host interface port 330 might be terminated prior to completion in response to the number of allocated read buffer entries 572 plus allocated write buffer entries 576 of the managed memory controller 305 decreasing to a number that is less than the first threshold. Alternatively, the process of FIG. 9 might be completed for each host interface port 330 of the plurality of host interface ports 330 in response to determining that the number of allocated read buffer entries 572 plus allocated write buffer entries 576 of the managed memory controller 305 is greater than or equal to the first threshold at 971.

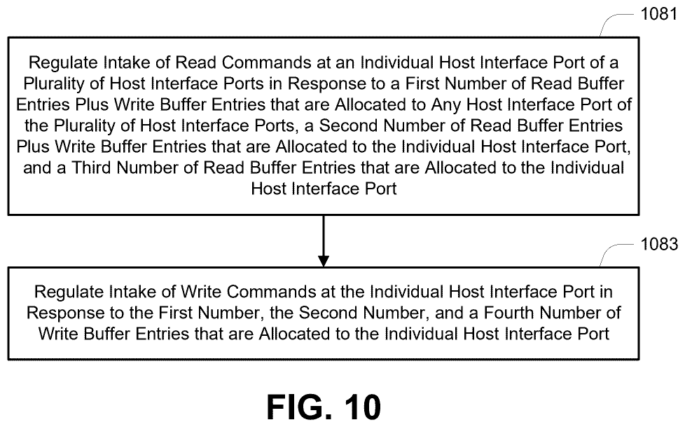

FIG. 10 is a flowchart of a method of operating a managed memory controller in accordance with a still further embodiment. The method might represent actions associated with regulating the intake of read and write commands by the managed memory controller 305. The method might be in the form of computer-readable instructions, e.g., stored to the storage registers 358. Such computer-readable instructions might be executed by a controller, e.g., the central controller 356, to cause the relevant components of the managed memory controller 305 to perform the method.

At 1081, the intake of read commands at an individual host interface port 330 of a plurality of host interface ports 330 might be regulated in response to a first number of read buffer entries 572 plus write buffer entries 576 that are allocated to any host interface port 330 of the plurality of host interface ports 330, a second number of read buffer entries 572 plus write buffer entries 576 that are allocated to the individual host interface port 330, and a third number of read buffer entries 572 that are allocated to the individual host interface port. The first number might correspond to a sum of fixed read buffer entries 572 (e.g., of the subsets of fixed read buffer entries 462₀-462_{P}), dynamic read buffer entries 572 (e.g., of the subset of dynamic read buffer entries 464), fixed write buffer entries 576 (e.g., of the subsets of fixed write buffer entries 466₀-466_{P}), and dynamic write buffer entries 576 (e.g., of the subset of dynamic write buffer entries 468) that are allocated to any host interface port 330 of the plurality of host interface ports 330. The second number might correspond to a sum of fixed read buffer entries 572 (e.g., of a respective subset of fixed read buffer entries 462₀-462_{P} for the individual host interface port 330), dynamic read buffer entries 572 (e.g., of the subset of dynamic read buffer entries 464), fixed write buffer entries 576 (e.g., of a respective subset of fixed write buffer entries 466₀-466_{P} for the individual host interface port 330), and dynamic write buffer entries 576 (e.g., of the subset of dynamic write buffer entries 468) that are allocated to the individual host interface port 330. The third number might correspond to a sum of fixed read buffer entries 572 (e.g., of the respective subset of fixed read buffer entries 462₀-462_{P} for the individual host interface port 330) and dynamic read buffer entries 572 (e.g., of the subset of dynamic read buffer entries 464) that are allocated to the individual host interface port 330.

At 1083, the intake of write commands at the individual host interface port 330 might be regulated in response to the first number, the second number, and a fourth number of write buffer entries 576 that are allocated to the individual host interface port. The fourth number might correspond to a sum of fixed write buffer entries 576 (e.g., of the respective subset of fixed write buffer entries 466₀-466_{P} for the individual host interface port 330) and dynamic write buffer entries 576 (e.g., of the subset of dynamic write buffer entries 468) that are allocated to the individual host interface port 330.

The process of FIG. 10 might be repeated for each host interface port 330 of the plurality of host interface ports 330. The process of 1081 to 1083 might be repeated for each host interface port 330 either sequentially or concurrently. The acts of 1081 and 1083 might further be performed concurrently or sequentially in either order.

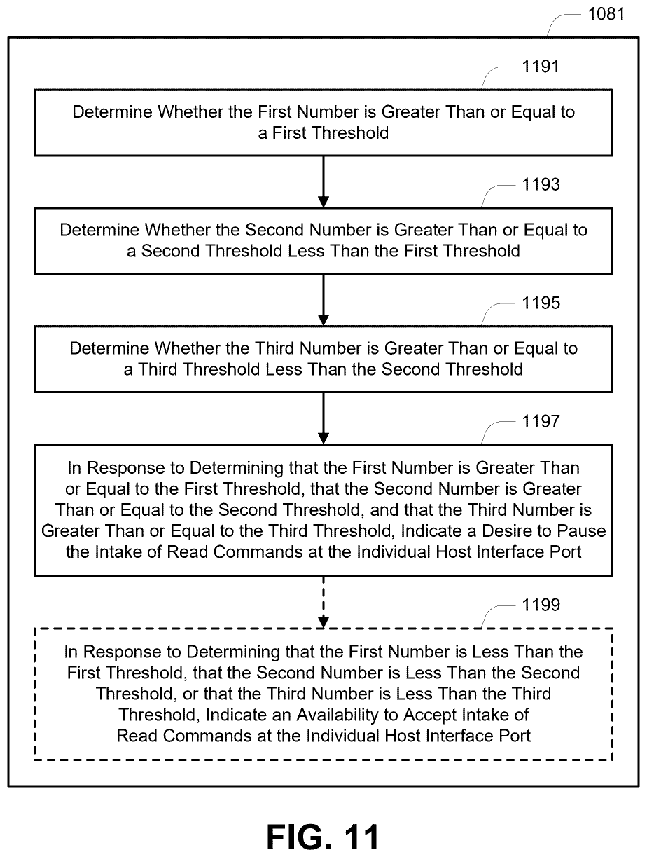

FIG. 11 is a flowchart of a method of operating a managed memory controller in accordance with one portion (e.g., 1081) of the flowchart of FIG. 10. The method might represent actions associated with regulating the intake of read commands by the managed memory controller 305, e.g., pausing or accepting the intake of read commands at one or more host interface ports 330 of the managed memory controller 305. The method might be in the form of computer-readable instructions, e.g., stored to the storage registers 358. Such computer-readable instructions might be executed by a controller, e.g., the central controller 356, to cause the relevant components of the managed memory controller 305 to perform the method.

At 1191, it might be determined whether the first number is greater than or equal to a first threshold. For example, the first number, e.g., the total number of read buffer entries 572 of the read buffer 334 and write buffer entries 576 of the write buffer 336 that are allocated to any host interface port 330, might be compared to the first threshold (e.g., MNAB_TH) to determine whether it is greater than or equal to the first threshold.

At 1193, it might be determined whether the second number is greater than or equal to a second threshold less than the first threshold. For example, the second number, e.g., the total number of read buffer entries 572 of the read buffer 334 and write buffer entries 576 of the write buffer 336 that are allocated to the individual host interface port 330 might be compared to the second threshold (e.g., BP_TH_i for a host interface port 330ᵢ) to determine whether it is greater than or equal to the second threshold.

At 1195, it might be determined whether the third number is greater than or equal to a third threshold less than the second threshold. For example, the third number, e.g., the total number of read buffer entries 572 of the read buffer 334 that are allocated to the individual host interface port 330 might be compared to the third threshold (e.g., MFRB_TH_i for a host interface port 330ᵢ) to determine whether it is greater than or equal to the third threshold.

At 1197, in response to determining that the first number is greater than or equal to the first threshold, that the second number is greater than or equal to the second threshold, and that the third number is greater than or equal to the third threshold, a desire to pause the intake of read commands at the individual host interface port 330 might be indicated.

At 1199, in response to determining that the first number is less than the first threshold, that the second number is less than the second threshold, or that the third number is less than the third threshold, an availability to accept the intake of read commands at the individual host interface port 330 might be indicated. Indicating an availability to accept the intake of read commands at the individual host interface port 330 might include not indicating a desire to pause the intake of read commands to the individual host interface port 330.

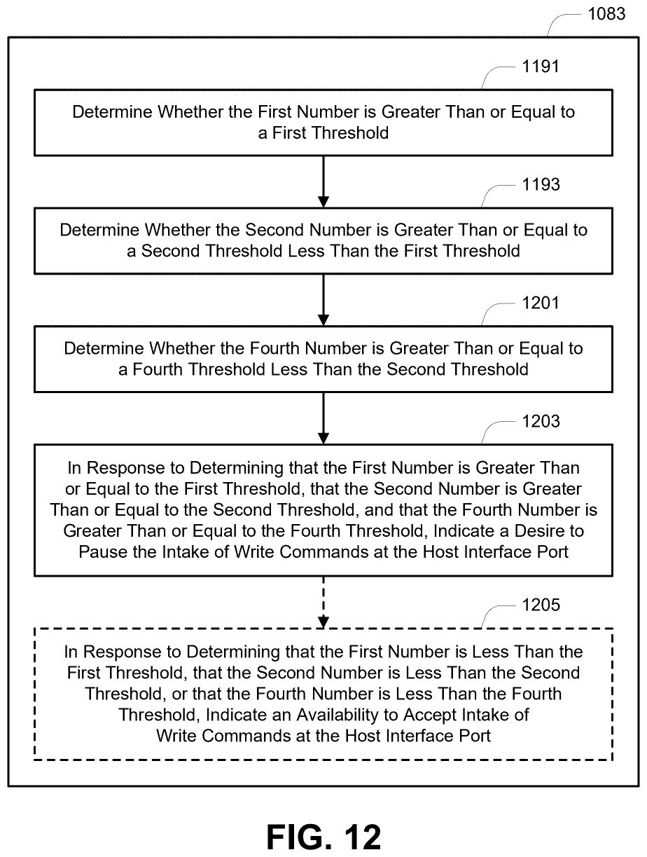

FIG. 12 is a flowchart of a method of operating a managed memory controller in accordance with a different portion (e.g., 1083) of the flowchart of FIG. 10. The method might represent actions associated with regulating the intake of write commands by the managed memory controller 305, e.g., pausing or accepting the intake of write commands at one or more host interface ports 330 of the managed memory controller 305. The method might be in the form of computer-readable instructions, e.g., stored to the storage registers 358. Such computer-readable instructions might be executed by a controller, e.g., the central controller 356, to cause the relevant components of the managed memory controller 305 to perform the method.

At 1191, it might be determined whether the first number is greater than or equal to a first threshold. For example, the first number, e.g., the total number of read buffer entries 572 of the read buffer 334 and write buffer entries 576 of the write buffer 336 that are allocated to any host interface port 330, might be compared to the first threshold (e.g., MNAB_TH) to determine whether it is greater than or equal to the first threshold.

At 1193, it might be determined whether the second number is greater than or equal to a second threshold less than the first threshold. For example, the second number, e.g., the total number of read buffer entries 572 of the read buffer 334 and write buffer entries 576 of the write buffer 336 that are allocated to the individual host interface port 330 might be compared to the second threshold (e.g., BP_TH_i for a host interface port 330ᵢ) to determine whether it is greater than or equal to the second threshold.

At 1201, it might be determined whether the fourth number is greater than or equal to a fourth threshold less than the second threshold. For example, the fourth number, e.g., the total number of write buffer entries 576 of the write buffer 336 that are allocated to the individual host interface port 330 might be compared to the fourth threshold (e.g., MFWB_TH_i for a host interface port 330ᵢ) to determine whether it is greater than or equal to the fourth threshold.

At 1203, in response to determining that the first number is greater than or equal to the first threshold, that the second number is greater than or equal to the second threshold, and that the fourth number is greater than or equal to the fourth threshold, a desire to pause the intake of write commands at the individual host interface port 330 might be indicated.

At 1205, in response to determining that the first number is less than the first threshold, that the second number is less than the second threshold, or that the fourth number is less than the fourth threshold, an availability to accept the intake of write commands at the individual host interface port 330 might be indicated. Indicating an availability to accept the intake of write commands at the individual host interface port 330 might include not indicating a desire to pause the intake of write commands to the individual host interface port 330.

### CONCLUSION

Although specific embodiments have been illustrated and described herein, it will be appreciated by those of ordinary skill in the art that any arrangement that is calculated to achieve the same purpose might be substituted for the specific embodiments shown. Many adaptations of the embodiments will be apparent to those of ordinary skill in the art. Accordingly, this application is intended to cover any adaptations or variations of the embodiments.

What is claimed is:

1. A managed memory controller, comprising:
a plurality of host interface ports configured for communicating with an external host;
a read buffer comprising a plurality of read buffer entries with each read buffer entry of the plurality of read buffer entries allocatable in response to a respective read command received by the managed memory controller;
a write buffer comprising a plurality of write buffer entries with each write buffer entry of the plurality of write buffer entries allocatable in response to a respective write command received by the managed memory controller; and
a central controller configured to cause the managed memory controller to:
regulate intake of read commands at an individual host interface port of the plurality of host interface ports in response to a first number of read buffer entries plus write buffer entries that are allocated to any host interface port of the plurality of host interface ports, a second number of read buffer entries plus write buffer entries that are allocated to the individual host interface port, and a third number of read buffer entries that are allocated to the individual host interface port; and
regulate intake of write commands at the individual host interface port in response to the first number, the second number, and a fourth number of write buffer entries that are allocated to the individual host interface port.

2. The managed memory controller of claim 1, wherein each host interface port of the plurality of host interface ports is configured to communicate with the external host using a Compute Express Link™ (CXL) protocol.

3. The managed memory controller of claim 1, wherein a number of host interface ports of the plurality of interface ports is an integer value P+1, and wherein the central controller is further configured to cause the managed memory controller to:
for one or more integer values of i from 0 to P:
regulate the intake of read commands at an i^{th} host interface port of the plurality of interface ports in response to the first number, a respective second number of read buffer entries plus write buffer entries that are allocated to the i^{th} host interface port, and a respective third number of read buffer entries that are allocated to the i^{th} host interface port; and
regulate the intake of write commands at the i^{th} host interface port in response to the first number, its respective second number, and a respective fourth number of write buffer entries that are allocated to the i^{th} host interface port.

4. The managed memory controller of claim 3, wherein the central controller is further configured to cause the managed memory controller to regulate the intake of read commands and the intake of write commands for each integer value of i from 0 to P.

5. The managed memory controller of claim 4, wherein the central controller is further configured to cause the managed memory controller to regulate the intake of read commands and the intake of write commands for each integer value of i from 0 to P concurrently.

6. The managed memory controller of claim 4, wherein the central controller is further configured to cause the managed memory controller to regulate the intake of read commands and the intake of write commands for each integer value of i from 0 to P sequentially.

7. The managed memory controller of claim 1, wherein the central controller is further configured to cause the managed memory controller to:
determine whether the first number is greater than or equal to a first threshold;
determine whether the second number is greater than or equal to a second threshold less than the first threshold;
determine whether the third number is greater than or equal to a third threshold less than the second threshold;
determine whether the fourth number is greater than or equal to a fourth threshold less than the second threshold;
in response to determining that the first number is greater than or equal to the first threshold, that the second number is greater than or equal to the second threshold, and that the third number is greater than or equal to the third threshold, indicate a desire to pause intake of read commands at the individual host interface port; and
in response to determining that the first number is greater than or equal to the first threshold, that the second number is greater than or equal to the second threshold, and that the fourth number is greater than or equal to the fourth threshold, indicate a desire to pause intake of write commands at the individual host interface port.

8. The managed memory controller of claim 7, wherein the central controller is further configured to cause the managed memory controller to:
in response to determining that the first number is less than the first threshold, that the second number is less than the second threshold, or that the third number is less than the third threshold, indicate an availability to accept intake of read commands at the individual host interface port; and
in response to determining that the first number is less than the first threshold, that the second number is less than the second threshold, or that the fourth number is less than the fourth threshold, indicate an availability to accept intake of write commands at the individual host interface port.

9. The managed memory controller of claim 8, wherein indicating an availability to accept intake of read commands at the individual host interface port comprises not indicating the desire to pause intake of read commands at the individual host interface port, and wherein indicating the availability to accept intake of write commands by the individual host interface port comprises not indicating the desire to pause intake of write commands at the individual host interface port.

10. The managed memory controller of claim 7, wherein the central controller is further configured to cause the managed memory controller to:
determine whether the second number is greater than or equal to the second threshold in response to determining that the first number is greater than or equal to the first threshold; and
determine whether the third number is greater than or equal to the third threshold and determine whether the fourth number is greater than or equal to the fourth threshold in response to determining that the second number is greater than or equal to the second threshold.

11. The managed memory controller of claim 7, wherein the central controller is further configured to cause the managed memory controller to:
concurrently determine whether the first number is greater than or equal to the first threshold, whether the second number is greater than or equal to the second threshold, whether the third number is greater than or equal to the third threshold, and whether the fourth number is greater than or equal to the fourth threshold.

12. A managed memory controller, comprising:
a plurality of host interface ports configured for communicating with an external host;
a read buffer comprising a plurality of read buffer entries with each read buffer entry of the plurality of read buffer entries allocatable in response to a respective read command received by the managed memory controller;
a write buffer comprising a plurality of write buffer entries with each write buffer entry of the plurality of write buffer entries allocatable in response to a respective write command received by the managed memory controller; and
a central controller configured to cause the managed memory controller to:
determine whether a number of allocated read buffer entries plus allocated write buffer entries of the managed memory controller is greater than or equal to a first threshold;
determine whether a number of allocated read buffer entries plus allocated write buffer entries for respective commands received at one host interface port of the plurality of host interface ports of the managed memory controller is greater than or equal to a second threshold less than the first threshold;
determine whether a number of allocated read buffer entries for respective read commands received at the one host interface port is greater than or equal to a third threshold less than the second threshold, and determine whether a number of allocated write buffer entries for respective write commands received at the one host interface port is greater than or equal to a fourth threshold less than the second threshold;
in response to determining that the number of allocated read buffer entries plus allocated write buffer entries of the managed memory controller is greater than or equal to the first threshold, that the number of allocated read buffer entries plus allocated write buffer entries for respective commands received at the one host interface port is greater than or equal to the second threshold, and that the number of allocated read buffer entries for respective read commands received at the one host interface port is greater than or equal to the third threshold, assert back pressure on a read path of the one host interface port; and
in response to determining that the number of allocated read buffer entries plus allocated write buffer entries of the managed memory controller is greater than or equal to the first threshold, that the number of allocated read buffer entries plus allocated write buffer entries for respective commands received at the one host interface port is greater than or equal to the second threshold, and that the number of allocated write buffer entries for respective write commands received at the one host interface port is greater than or equal to the fourth threshold, assert back pressure on a write path of the one host interface port.

13. The managed memory controller of claim 12, wherein the central controller is further configured to cause the managed memory controller to:
in response to determining that the number of allocated read buffer entries plus allocated write buffer entries of the managed memory controller is less than the first threshold, that the number of allocated read buffer entries plus allocated write buffer entries for respective commands received at the one host interface port is less than the second threshold, or that the number of allocated read buffer entries for respective read commands received at the one host interface port is less than the third threshold, de-assert back pressure on the read path of the one host interface port.

14. The managed memory controller of claim 13, wherein the central controller is further configured to cause the managed memory controller to:
in response to determining that the number of allocated read buffer entries plus allocated write buffer entries of the managed memory controller is less than the first threshold, that the number of allocated read buffer entries plus allocated write buffer entries for respective commands received at the one host interface port is less than the second threshold, or that the number of allocated write buffer entries for respective write commands received at the one host interface port is less than the fourth threshold, de-assert back pressure on the write path of the host interface port.

15. The managed memory controller of claim 12, wherein the central controller is further configured to cause the managed memory controller to:
concurrently determine whether the number of allocated read buffer entries plus allocated write buffer entries of the managed memory controller is greater than or equal to the first threshold, whether the number of allocated read buffer entries plus allocated write buffer entries for respective commands received at the one host interface port is greater than or equal to the second threshold, whether the number of allocated read buffer entries for respective read commands received at the one host interface port is greater than or equal to the third threshold, and whether the number of allocated write buffer entries for respective write commands received at the one host interface port is greater than or equal to the fourth threshold.

16. The managed memory controller of claim 12, wherein the central controller is further configured to cause the managed memory controller to:
determine whether the number of allocated read buffer entries plus allocated write buffer entries for respective commands received at the one host interface port is greater than or equal to the second threshold in response to determining that the number of allocated read buffer entries plus allocated write buffer entries of the managed memory controller is greater than or equal to the first threshold; and
determine whether the number of allocated read buffer entries for respective read commands received at the one host interface port is greater than or equal to the third threshold and whether the number of allocated write buffer entries for respective write commands received at the one host interface port is greater than or equal to the fourth threshold in response to determining that the number of allocated read buffer entries plus allocated write buffer entries for respective commands received at the one host interface port is greater than or equal to the second threshold.

17. An apparatus, comprising:
a plurality of memory devices; and
a managed memory controller in communication with each memory device of the plurality of memory devices, wherein the managed memory controller comprises:
a plurality of host interface ports configured for communicating with an external host;
a read buffer comprising a plurality of read buffer entries, wherein the plurality of read buffer entries comprises a subset of dynamic read buffer entries with each of the dynamic read buffer entries allocatable in response to a respective read command received at any host interface port of the plurality of host interface ports, and a plurality of subsets of fixed read buffer entries with each subset of fixed read buffer entries corresponding to a respective host interface port of the plurality of host interface ports with each of the fixed read buffer entries allocatable in response to a respective read command received at its respective host interface port;
a write buffer comprising a plurality of write buffer entries, wherein the plurality of write buffer entries comprises a subset of dynamic write buffer entries with each of the dynamic write buffer entries allocatable in response to a respective write command received at any host interface port of the plurality of host interface ports, and a plurality of subsets of fixed write buffer entries with each subset of fixed write buffer entries corresponding to a respective host interface port of the plurality of host interface ports with each of the fixed write buffer entries allocatable in response to a respective write command received at its respective host interface port;
a central controller configured to cause the managed memory controller to:
regulate intake of read commands at an individual host interface port of the plurality of host interface ports in response to a first number corresponding to a sum of fixed read buffer entries, dynamic read buffer entries, fixed write buffer entries, and dynamic write buffer entries that are allocated to any host interface port of the plurality of host interface ports, a second number corresponding to a sum of fixed read buffer entries, dynamic read buffer entries, fixed write buffer entries, and dynamic write buffer entries that are allocated to the individual host interface port, and a third number corresponding to a sum of fixed read buffer entries and dynamic read buffer entries that are allocated to the individual host interface port; and
regulate intake of write commands at the individual host interface port in response to the first number, the second number, and a fourth number corresponding to a sum of fixed write buffer entries and dynamic write buffer entries that are allocated to the individual host interface port.

18. The apparatus of claim 17, wherein a number of host interface ports of the plurality of interface ports is an integer value P+1, and wherein the central controller is further configured to cause the managed memory controller to:
for one or more integer values of i from 0 to P:
regulate intake of read commands at an i^{th} host interface port of the plurality of host interface ports in response to a first number corresponding to a sum of fixed read buffer entries, dynamic read buffer entries, fixed write buffer entries, and dynamic write buffer entries that are allocated to any host interface port of the plurality of host interface ports, a respective second number corresponding to a sum of fixed read buffer entries, dynamic read buffer entries, fixed write buffer entries, and dynamic write buffer entries that are allocated to the i^{th} host interface port, and a respective third number corresponding to a sum of fixed read buffer entries and dynamic read buffer entries that are allocated to the i^{th} host interface port; and
regulate intake of write commands at the i^{th} host interface port in response to the first number, the respective second number, and a respective fourth number corresponding to a sum of fixed write buffer entries and dynamic write buffer entries that are allocated to the i^{th} host interface port.

19. The apparatus of claim 17, wherein the central controller is further configured to cause the managed memory controller to:
determine whether the first number is greater than or equal to a first threshold;
determine whether the second number is greater than or equal to a second threshold less than the first threshold;
determine whether the third number is greater than or equal to a third threshold less than the second threshold;
determine whether the fourth number is greater than or equal to a fourth threshold less than the second threshold;
in response to determining that the first number is greater than or equal to the first threshold, that the second number is greater than or equal to the second threshold, and that the third number is greater than or equal to the third threshold, indicate a desire to pause intake of read commands at the individual host interface port; and
in response to determining that the first number is greater than or equal to the first threshold, that the second number is greater than or equal to the second threshold, and that the fourth number is greater than or equal to the fourth threshold, indicate a desire to pause intake of write commands at the individual host interface port.

20. The apparatus of claim 19, wherein the central controller is further configured to cause the managed memory controller to:
in response to determining that the first number is less than the first threshold, that the second number is less than the second threshold, or that the third number is less than the third threshold, indicate an availability to accept intake of read commands at the individual host interface port; and
in response to determining that the first number is less than the first threshold, that the second number is less than the second threshold, or that the fourth number is less than the fourth threshold, indicate an availability to accept intake of write commands at the individual host interface port.
